(19) United States
(12) Patent Application Publication
(10) Pub. No.: US 2026/0178226 A1
(43) Pub. Date: Jun. 25, 2026

(54) MEMORY CIRCUIT

(71) Applicant: Socionext Inc., Kanagawa (JP)

(72) Inventors: Tatsushi OTSUKA, Yokohama (JP); Masanobu HIROSE, Yokohama (JP); Yuya SHIGENOBU, Yokohama (JP)

(21) Appl. No.: 19/421,010

(22) Filed: Dec. 16, 2025

(30) Foreign Application Priority Data
Dec. 25, 2024 (JP) 2024-228207

(51) Int. Cl. G06F 3/06

(52) U.S. Cl. CPC G06F 3/0658; G06F 3/0625; G06F 3/0673

(57) ABSTRACT

A memory circuit includes groups that execute a write or read in response to a request, each group includes memories each including memory cells, group controllers provided in correspondence with the groups, a controller that outputs a request received from outside to an adjacent group controller, and a data converter that divides a first write data received from the controller into n (>=2) second write data that are sequentially output to the adjacent group controller. The group controllers sequentially write the n second write data into one memory of a corresponding group in a case where a write address included in the request received from the controller or a group controller of a preceding stage indicates the corresponding group, and transfers the request and the n second write data to the group controller of the preceding stage in a case where the write address does not indicate the corresponding group.

### CROSS-REFERENCE TO RELATED APPLICATIONS

This application is based upon and claims priority to Japanese Patent Application No. 2024-228207, filed on December 25, 2024, the entire contents of which are incorporated herein by reference.

### FIELD

Certain aspects of the embodiments discussed herein are related to memory circuits.

### BACKGROUND

A known memory circuit includes memories and memory controllers that control the memories arranged repeatedly, and a memory controller sequentially transfers a control signal to a memory controller of a subsequent stage. Each memory controller outputs a memory access request to a corresponding memory in a case where an address included in the memory access request indicates the corresponding memory, and outputs a memory access request to a memory controller of a subsequent stage in a case where the address included in the memory access request indicates a memory other than the corresponding memory (refer to International Publication Pamphlet No. WO 2023/089778 and Japanese Laid-Open Patent Publication No. 2006-65697, for example).

A known static random access memory (SRAM) includes a plurality of memory cells connected to one word line, a sense amplifier shared by the plurality of memory cells, and selection switches arranged between the plurality of memory cells and the sense amplifier, and can perform a burst read operation and a burst write operation. During the burst read operation of this type of SRAM, the sense amplifier sequentially amplifies data signals read in parallel from a plurality of memory cells by activating the word line, and outputs the amplified data signals as a serial data signal. On the other hand, during the burst write operation, the memory cell array writes the serial data signal to the plurality of memory cells as parallel data signals by the selection switches that are sequentially turned on. The word line is activated only at the beginning of a burst access operation or is activated during the burst access operation (refer to U.S. Patent Application Publication No. 2021/0193196 and U.S. Patent Application Publication No. 2023/0075959, for example).

For example, in a case where only a part of the data read from the plurality of memory cells connected to the word line and amplified by the sense amplifier is output to external data terminals during a read operation, the operation of amplifying the data that is not output from the external data terminals becomes redundant, resulting in unnecessary power consumption. In addition, as a bit width of the data signals input to and output from a memory block including the memory cells becomes larger, charge and discharge currents of data lines transmitting the data signals within the memory block become larger, and a dynamic power of the memory circuit becomes larger. Particularly, in the memory circuit in which the memories and the memory controllers are arranged repeatedly, the data lines are likely to become long, and the charge and discharge currents of the data lines greatly affect the dynamic power of the memory circuit.

### SUMMARY

It is an object in one aspect of the embodiments of the present disclosure to reduce a dynamic power during a memory access operation.

According to one aspect of the embodiments of the present disclosure, a memory circuit includes a plurality of memory groups configured to execute a write operation or a read operation in response to a request signal, each memory group of the plurality of memory groups including a plurality of memories, each memory of the plurality of memories including a plurality of memory cells; a plurality of memory group controllers provided in correspondence with the plurality of memory groups, respectively; a first memory controller configured to output a request signal received from outside to an adjacent memory group controller of the plurality of memory group controllers; and a first data converter configured to divide a first write data signal received from the first memory controller into n second write data signals, and sequentially output the n second write data signals to the adjacent memory group controller, where n is an integer greater than or equal to two, wherein the plurality of memory group controllers sequentially write the n second write data signals into one memory of the plurality of memories of a corresponding memory group in a case where a write address signal included in the request signal received from the first memory controller or a memory group controller of a preceding stage indicates the corresponding memory group, and transfers the request signal and the n second write data signals to the memory group controller of the preceding stage in a case where the write address signal does not indicate the corresponding memory group.

The object and advantages of the embodiments will be realized and attained by means of the elements and combinations particularly pointed out in the claims.

It is to be understood that both the foregoing general description and the following detailed description are exemplary and explanatory and not restrictive of the invention, as claimed.

### BRIEF DESCRIPTION OF THE DRAWINGS

FIG. 1 is a block diagram illustrating an example of a configuration of a memory circuit according to a first embodiment;

FIG. 2 is a block diagram illustrating an example of a memory controller illustrated in FIG. 1;

FIG. 3 is a block diagram illustrating an example of a configuration of a memory block illustrated in FIG. 1;

FIG. 4 is a block diagram illustrating an example of a configuration of a memory group illustrated in FIG. 3;

FIG. 5 is a block diagram illustrating an example of a configuration of a memory unit illustrated in FIG. 4;

FIG. 6 is a block diagram illustrating an example of an internal configuration of a memory MEM included in the memory unit illustrated in FIG. 5;

FIG. 7 is a block diagram illustrating a read operation of column circuitry illustrated in FIG. 6 from a viewpoint of individual read data signals;

FIG. 8 is a block diagram illustrating a write operation by the column circuitry illustrated in FIG. 6 from a viewpoint of individual write data signals;

FIG. 9 is a diagram illustrating an example of a memory circuit including a memory block which receives q 512-bit write data signal from a memory controller and outputs a 512-bit read data signal to the memory controller;

FIG. 10 is a block diagram illustrating an example of an internal configuration of a sub-memory illustrated in FIG. 9;

FIG. 11 is a timing chart illustrating an outline of a read operation of the memory MEM included in the memory unit of the memory circuit illustrated in FIG. 6 and the sub-memory included in the memory block of the memory circuit illustrated in FIG. 10;

FIG. 12 is a timing chart illustrating an example of a read operation and a write operation of the memory illustrated in FIGS. 6, 7, and 8;

FIG. 13 is a timing chart illustrating an example of a read operation and a write operation of the sub-memory illustrated in FIG. 10;

FIG. 14 is a block diagram illustrating an example of a configuration of a memory group controller illustrated in FIG. 1;

FIG. 15 is a timing chart illustrating an example of generating a memory clock signal MCLK from a memory clock signal MCLKxN;

FIG. 16 is a state transition diagram illustrating an example of transitions of an operation state of the memory unit illustrated in FIG. 4;

FIG. 17 is a flow chart illustrating an example of an operation of the memory group controller illustrated in FIG. 14;

FIG. 18 is a flow chart illustrating an example of step S100 illustrated in FIG. 17.

FIG. 19 is a flow chart illustrating an example of step S200 illustrated in FIG. 17;

FIG. 20 is a flow chart illustrating an example of step S220 illustrated in FIG. 19;

FIG. 21 is a flow chart illustrating an example of step S300 illustrated in FIG. 17;

FIG. 22 is a diagram for explaining an example of an operation for causing a transition of the memory unit to an active mode in the memory circuit illustrated in FIG. 1;

FIG. 23 is a timing chart illustrating an example of timings of signals when making the transition to the active mode in FIG. 22;

FIG. 24 is a timing chart illustrating a continuation of FIG. 23;

FIG. 25 is a diagram for explaining an example of a write operation of the memory circuit illustrated in FIG. 1;

FIG. 26 is a timing chart illustrating an example of timings of signals during the write operation illustrated in FIG. 18;

FIG. 27 is a timing chart illustrating a continuation of FIG. 26;

FIG. 28 is a diagram for explaining an example of a read operation of the memory circuit illustrated in FIG. 1;

FIG. 29 is a timing chart illustrating an example of timings of signals during the read operation illustrated in FIG. 28;

FIG. 30 is a timing chart illustrating a continuation of FIG. 29;

FIG. 31 is a timing chart illustrating a continuation of FIG. 30;

FIG. 32 is a timing chart illustrating a continuation of FIG. 31;

FIG. 33 is a timing chart illustrating another example of the timings of signals during the read operation of the memory circuit illustrated in FIG. 1;

FIG. 34 is a timing chart illustrating a continuation of FIG. 33;

FIG. 35 is a timing chart illustrating a continuation of FIG. 34;

FIG. 36 is a timing chart illustrating a continuation of FIG. 35;

FIG. 37 is a block diagram illustrating an example of a configuration of the memory circuit according to a second embodiment; and

FIG. 38 is a block diagram illustrating an example of a configuration of a system mounted with the memory circuit illustrated in FIG. 1.

### DESCRIPTION OF EMBODIMENTS

Hereinafter, embodiments of the present disclosure will be described with reference to the drawings. In the following description, a signal line through which information, such as a signal or the like, is transmitted is denoted by the same reference numeral as the name of the signal. A signal line indicated by a bold line indicates that the signal line is configured by a plurality of bits. A signal line indicated by a single line may be configured by a plurality of bits.

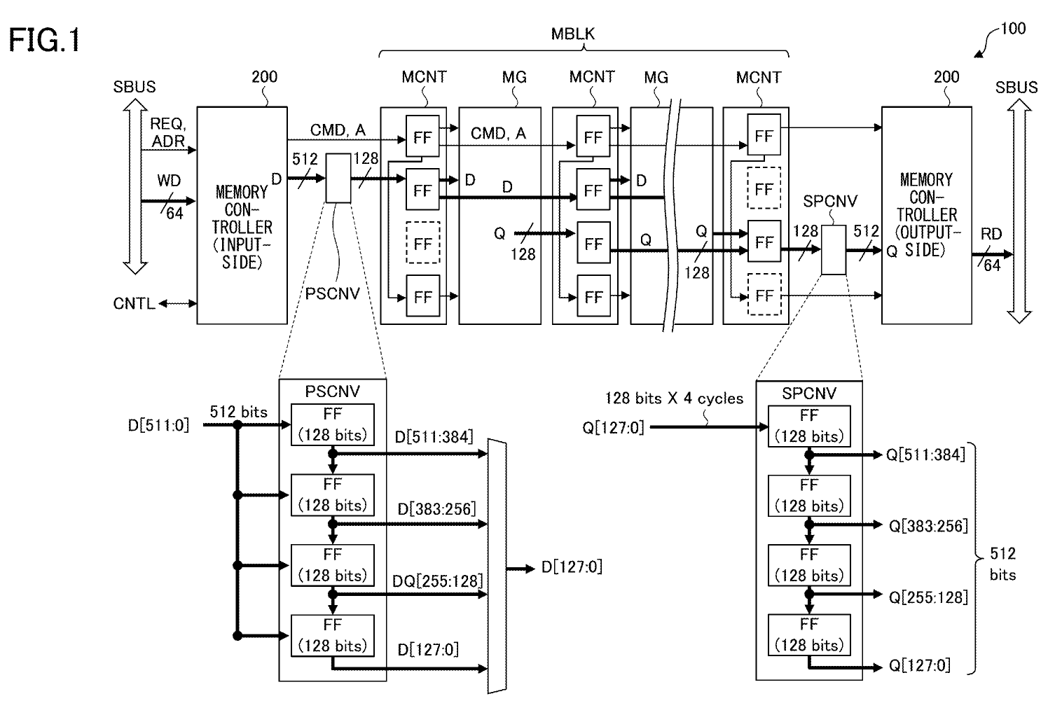

FIG. 1 illustrates an example of a configuration of a memory circuit according to a first embodiment. A memory circuit 100 illustrated in FIG. 1 is mounted on a semiconductor device, such as a system large scale integrated (LSI) circuit or the like that processes image data, for example. For example, the semiconductor device including the memory circuit 100 can be implemented in an imaging device, such as a monitoring camera or the like, a head-mounted device, such as augmented reality/virtual reality (AR/VR) glasses (or headset) or the like, a digital camera, or the like. The imaging device or the like generates video data or the like to be displayed on a display device.

The memory circuit 100 includes a memory block MBLK, an input-side memory controller 200 and a data converter PSCNV connected in series to an input side of the memory block MBLK, and a data converter SPCNV and an output-side memory controller 200 connected in series to an output side of the memory block MBLK. The input-side memory controller 200 is an example of a first memory controller, and the output-side memory controller 200 is an example of a second memory controller. Hereinafter, the input-side memory controller 200 and the output-side memory controller 200 will simply be referred to as "the memory controller 200" when not distinguishing between the input-side memory controller 200 and the output-side memory controller 200.

The memory block MBLK includes a plurality of memory groups MG arranged in one direction and including a plurality of memory cells, respectively, and a plurality of memory group controllers MCNT arranged in the one direction and on signal input sides of the plurality of memory groups MG, respectively. The memory block MBLK includes a memory group controller MCNT arranged on a signal output side of the memory group MG of a last stage. For example, each memory group MG is arranged between a pair of memory group controllers MCNT. In other words, the memory group controllers MCNT and the memory groups MG are alternately arranged. The memory group controller MCNT functions as an interface circuit for signals input and output between the memory controller 200 and the memory group MG or an interface circuit for signals input and output between the memory group controllers MCNT.

Each memory group controller MCNT includes flip-flop circuits FF that receive an access request signal (a control signal CMD, an address signal A, or the like), a write data signal D, and a read data signal Q, respectively. In a case where the memory group controller MCNT receives the access request signal with respect to the memory group MG adjacent to the output side thereof (hereinafter, also referred to as the memory group MG belonging to the memory group controller MCNT or simply the memory group controller MCNT's own memory group MG), the memory group controller MCNT outputs the access request signal to the memory group controller MCNT's own memory group MG.

In this case, each memory group controller MCNT suppresses the output of the access request signal to the memory group controller MCNT of a subsequent stage except for the signal to be used in the memory group controller MCNT of the last stage. The memory group controller MCNT of the subsequent stage refers to the memory group controller MCNT located closer to the output-side memory controller 200 than to the input-side memory controller 200 with respect to a target memory group controller MCNT with one memory group MG interposed between the target memory group controller MCNT and the memory group controller MCNT of the subsequent stage.

In addition, in a case where the memory group controller MCNT receives the access request with respect to a memory group MG other than the memory group controller MCNT's own memory group MG, the memory group controller MCNT transfers the access request signal to the memory group controller MCNT of the subsequent stage. In this case, the memory group controller MCNT suppresses the output of the access request signal to the memory group controller MCNT's own memory group MG.

The memory group controller MCNT transfers the read data signal Q read from the memory group controller MCNT's own memory group MG or the read data signal Q transferred from the memory group controller MCNT pf the preceding stage during the read operation to the memory group controller MCNT of the subsequent stage. The memory group controller MCNT of the preceding stage refers to the memory group controller MCNT located closer to the input-side memory controller 200 than to the output-side memory controller 200 with respect to the target memory group controller MCNT with one memory group MG interposed between the target memory group controller MCNT and the memory group controller MCNT of the preceding stage.

Accordingly, the memory block MBLK can control the access for each memory group MG by each memory group controller MCNT. In the memory block MBLK, the control line CMD, the address line A, the write data line D, and the read data line Q are not wired over a long distance across the plurality of memory groups MG, and thus, an increase in a wiring load can be suppressed. As a result, it is possible to suppress an increase in dynamic power, which is power consumption during the access operation, while suppressing an increase in an access time of the memory circuit 100.

Moreover, clock cycles required for transferring the access request signal, the write data signal D, and the read data signal Q between the pair of memory group controllers MCNT arranged on both sides of the memory group MG are set to be the same as each other. Accordingly, even in a case where the number of memory groups MG is increased or decreased to newly design another memory circuit having a different storage capacity, a timing design can easily be performed.

The memory controller 200 is connected to a system bus SBUS of the semiconductor device and a peripheral bus that inputs and outputs various control signals CNTL. Although not particularly limited, the system buses SBUS may input and output signals based on advanced extensible interface 4 (AXI4) manufactured by ARM Holdings plc, for example. The memory controller 200 functions as an interface circuit for signals input to and output from the system bus SBUS and for signals input to and output from the memory group controllers MCNT.

FIG. 1 illustrates an example in which columns of the memory group controllers MCNT and the memory groups MG are arranged in series between the input-side memory controller 200 and the output-side memory controller 200. However, the columns of the memory group controllers MCNT and the memory groups MG may be arranged in a U-shape. In this case, the input-side memory controller 200 and the output-side memory controller 200 are collectively arranged on one end of an area in which the memory group controllers MCNT and the memory groups MG are arranged.

The input-side memory controller 200 receives a request signal REQ for causing the memory circuit 100 to perform a memory access operation (a read operation or a write operation), an address signal ADR, a write data signal WD, or the like from a host controller, such as a central processing unit (CPU) or the like, via the system bus SBUS. The request signal REQ corresponds to the access request signal for causing the memory group MG to perform a write operation or a read operation. The access request signal indicates a write request or a read request. In FIG. 1, only the flow of main information signals is illustrated for the sake of simplicity. Although not illustrated, there are additional information, a signal indicating whether each signal is active or inactive, a control signal indicating an output instruction, an import instruction, or the like of a data signal.

The input-side memory controller 200 generates a control signal CMD including additional information for accessing the memory in the memory group MG, based on the address signal ADR and the request signal REQ including information such as a request ID, an access size, or the like. The input-side memory controller 200 outputs the generated control signal CMD to the memory group controller MCNT of a first stage.

For example, the input-side memory controller 200 outputs a 512-bit write data signal D to the data converter PSCNV every time a 64-bit write data signal WD is received eight times. The write data signal WD is an example of a third write data signal. The data converter PSCNV sequentially converts the 512-bit write data signal D output from the input-side memory controller 200 into four 128-bit write data signals D, and sequentially outputs the four converted write data signals D to the memory group controller MCNT of the first stage. The 512-bit write data signal D is an example of a first write data signal, the four 128-bit write data signals D are an example of a second write data signal, and the data converter PSCNV is an example of a first data converter.

The input-side memory controller 200 receives a control signal CNTL for setting operational specifications of at least one of the memory group MG or the memory group controller MCNT via the peripheral bus. Further, the input-side memory controller 200 outputs the operational specifications of at least one of the memory group MG or the memory group controller MCNT to the peripheral bus as the control signal CNTL. For example, the peripheral bus is an interface with a slower speed than the system bus SBUS.

The output-side memory controller 200 receives an access control signal, such as the control signal CMD, the address signal A, or the like from the memory group controller MCNT of the last stage. In addition, the output-side memory controller 200 receives the read data signal Q from the memory group controller MCNT of the last stage via the data converter SPCNV, and outputs the read data signal Q to the system bus SBUS as a read data signal RD. The read data signal RD is an example of a third read data signal. For example, the output-side memory controller 200 outputs the 64-bit read data signal RD eight times every time the 512-bit read data signal Q is received from the data converter SPCNV. That is, the memory controller 200 converts the parallel read data signals Q read from the memory group MG and output from the data converter SPCNV into the serial read data signal RD, and outputs the serial read data signal RD to the system bus SBUS.

The data converter SPCNV converts the four 128-bit read data signals Q sequentially output from the memory group controller MCNT of the last stage into the 512-bit read data signal Q, and outputs the converted 512-bit read data signal Q to the output-side memory controller 200. The four 128-bit read data signals Q are an example of a first read data signal, and the 512-bit read data signal Q is an example of a second read data signal.

The data converter SPCNV includes four flip-flop circuits FF connected in series. Each flip-flop circuit FF holds the 128-bit read data signal Q and outputs the held 128-bit read data signal Q to the output-side memory controller 200. Each flip-flop circuit FF of the flip-flop circuits FF other than the flip-flop circuit FF of the last stage outputs the held 128-bit read data signal Q to the flip-flop circuit FF of the next stage. The data converter SPCNV is an example of a second data converter.

In this embodiment, the 128-bit write data signal D output from the input-side memory controller 200 is converted into four 512-bit write data signals D by the data converter PSCNV and supplied to the memory block MBLK. For this reason, the number of write data lines D wired in the memory block MBLK can be reduced to one-fourth compared to a case where the data converter PSCNV is not used.

Similarly, the four 128-bit read data signals Q output from the memory block MBLK are converted into the 512-bit read data signal Q by the data converter SPCNV and output to the output-side memory controller 200. For this reason, the number of the read data lines Q wired in the memory block MBLK can be reduced to one-fourth compared to a case where the data converter SPCNV is not used.

The 128-bit data signal input to and output from the memory block MBLK is two times the 64-bit data signal input to and output from the system bus SBUS. For this reason, an operating frequency of the memory block MBLK can ideally be set to one-half the operating frequency of the system bus SBUS. Hence, the power consumption during the access operation of the memory block MBLK can be reduced compared to the case where the 64-bit data signal is input to and output from the memory block MBLK. Because the operating frequency of the memory block MBLK can be lowered, it is possible to allow for a sufficient operating margin of the memory group controller MCNT and the memory group MG, and the timing design or the like of the circuit can easily be performed.

The number of bits of the data signal input to and output from the memory block MBLK may be 2^{k} times the number of bits of the data signal input to and output from the system bus SBUS, where k is an integer greater than or equal to 1, and k = 1 in this example.

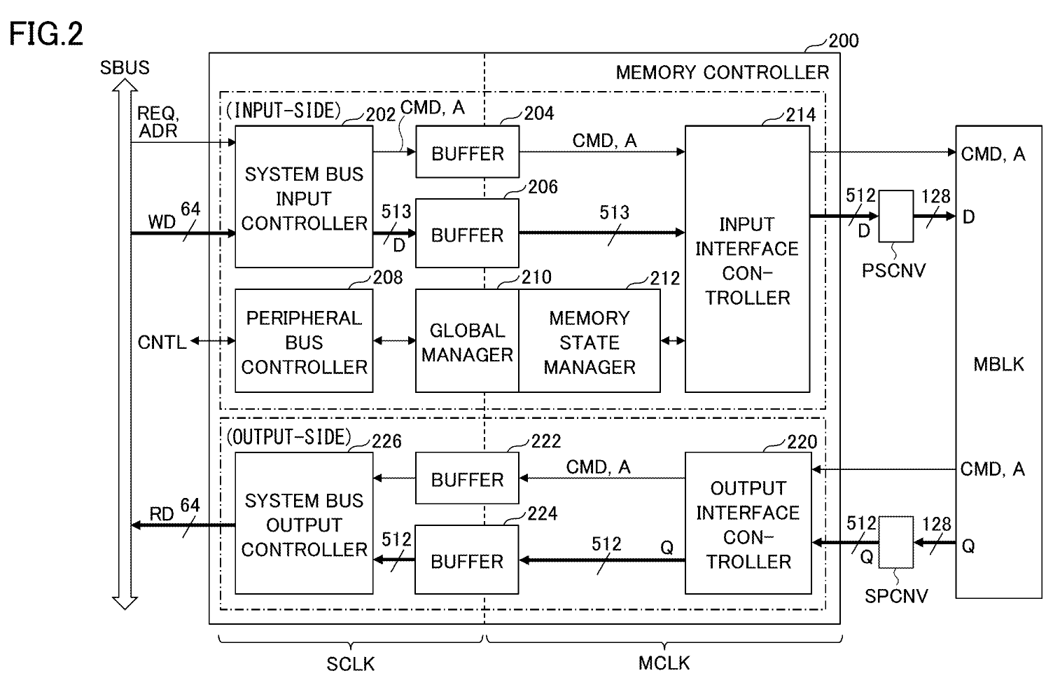

FIG. 2 illustrates an example of a circuit block of the memory controller 200 illustrated in FIG. 1. The input-side memory controller 200 includes a system bus input controller 202, buffers 204 and 206, a peripheral bus controller 208, a global manager 210, a memory state manager 212, and an input interface controller 214. The output-side memory controller 200 includes an output interface controller 220, buffers 222 and 224, and a system bus output controller 226.

The system bus input controller 202 generates the address signal A and the control signal CMD including the additional information for the memory control from the address signal ADR and the request signal REQ including the information such as the request ID, the access size, or the like, and stores the address signal A and the control signal CMD in the buffer 204. The system bus input controller 202 stores, in the buffer 206, a total of 513 bits (hereinafter, a description of a last signal will be omitted unless indicated otherwise, and the total is assumed to be 512 bits) of the 512-bit data signal obtained by receiving the write data signal WD from the system bus SBUS eight times at a maximum and 1-bit additional information (last information).

The buffers 204 and 206 are first-in-first-out (FIFO) buffers, for example. The buffer 204 outputs the control signal CMD and the address signal A to the input interface controller 214 in the order held. The buffer 206 outputs the write data signals WD to the input interface controller 214 in the order held.

In a case where the control signal CMD received from the buffer 204 is active, the input interface controller 214 outputs the control signal CMD, the address signal A, or the like for causing the memory block MBLK to perform a write operation or a read operation to the memory block MBLK. The input interface controller 214 outputs the 512-bit write data signal D corresponding to a write request signal indicating the write request from the buffer 204 to the data converter PSCNV.

The peripheral bus controller 208 outputs various control signals CNTL received from the peripheral bus to the global manager 210. The peripheral bus controller 208 outputs various control signals CNTL received from the global manager 210 to the peripheral bus.

The global manager 210 includes a plurality of registers (not illustrated) for setting the operational specifications, such as an operation mode or the like of the memory group MG (FIG. 1). The global manager 210 sets registers according to the various control signals CNTL from the peripheral bus. For example, the operation mode includes a shutdown mode, a sleep mode, and an active mode. For example, the shutdown mode, the sleep mode, and the active mode are switched in units of a memory unit MU which will be described later. The switching unit of the shutdown mode, the sleep mode, and the active mode is not limited to the memory unit MU.

For example, in the shutdown mode, power to a memory cell area is cut off in the memory unit MU to be shut down, and the power of peripheral circuits not related to the control of the shutdown and the sleep is cut off in the peripheral circuits outside the memory cell area. In the sleep mode, the power to the memory cell area is lowered to a low voltage at which the data held in the memory cell can be maintained in the memory unit MU to be put into sleep, and the power of the peripheral circuits not related to the control of shutdown and the sleep is cut off in the peripheral circuits outside the memory cell area.

In an example described in this embodiment, the memory block MBLK itself includes a power supply circuit for a shutdown function or a sleep function, but even in a case where the memory block MBLK itself does not include the power supply circuit, the switching control of the shutdown mode, the sleep mode, and the active mode can be performed as long as an adjustment of a power supply voltage of the memory cell area, an adjustment of the power supply voltage or a cutoff of the power supply of the peripheral circuits outside the memory cell area can be performed in units of the memory units MU or in units of the memory groups MG by a power supply circuit provided outside the memory block MBLK.

In the active mode, the write operation or the read operation can be performed. Further, in a register of the memory state manager 212, a time until a transition to the sleep mode may be set when there is no access during the active mode.

The memory state manager 212 manages the operation mode of the memory units MU based on the setting values of a plurality of built-in registers of the memory state manager 212. The memory state manager 212 may hold defect information indicating a location of a defective memory cell in the memory group MG, and perform a defect recovery management for redirecting access to a functional memory cell in place of the defective memory cell.

During the read operation of the memory block MBLK, the output interface controller 220 stores the control signal CMD and the address signal A received from the memory block MBLK in the buffer 222. The output interface controller 220 stores the 512-bit read data signal Q received from the data converter SPCNV in the buffer 224.

The buffers 222 and 224 are FIFO buffers, for example. The buffer 222 outputs the control signal CMD including the additional information for the memory control and the address signal A to the system bus output controller 226 in the order held. The buffer 224 outputs the 512-bit read data signal Q received from the output interface controller 220 to the system bus output controller 226.

The memory controller 200 has a function of performing a mutual conversion between a frequency of the data signal or the like input to and output from the system bus SBUS and a frequency of the data signal or the like input to and output from the memory block MBLK. For example, in the memory controller 200, the input sides of the buffers 204 and 206 operate with a system clock signal SCLK used in the system bus SBUS. In the memory controller 200, the output sides of the buffers 204 and 206 operate with a memory clock signal MCLK used in the memory block MBLK.

Similarly, in the memory controller 200, the input sides of the buffers 222 and 224 operate with the memory clock signal MCLK used in the memory block MBLK. In the memory controller 200, the output sides of the buffers 222 and 224 operate with the system clock signal SCLK used in the system bus SBUS. Accordingly, the buffers 204, 206, 222, and 224 also operate as clock transfer circuits.

The system bus output controller 226 receives the control signal CMD including the additional information for the memory control and the address signal A, which are output from the buffer 222, and the 512-bit read data signal Q, which is output from the buffer 224. The system bus output controller 226 sequentially outputs the 512-bit read data signal Q to the system bus SBUS as a maximum of eight 64-bit read data signals RD, according to the control signal CMD including the additional information for the memory control and the address signal A. Depending on the address signal A or the size information included in the additional information, a data signal other than the data signal to be accessed may be included in the 512-bit read data signal Q. Only the data signal to be accessed is output to the system bus SBUS.

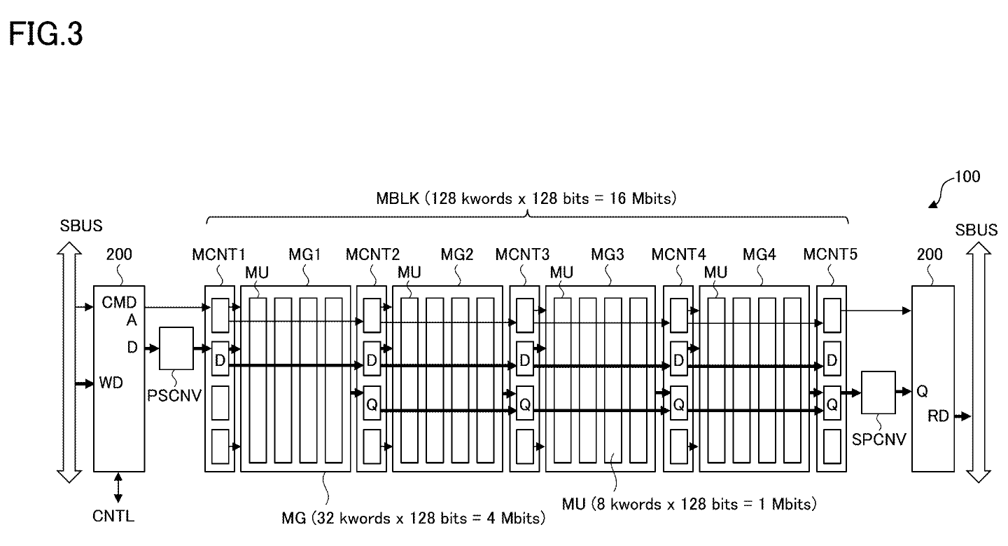

FIG. 3 illustrates an example of the configuration of the memory block MBLK illustrated in FIG. 1. In the following description, the memory block MBLK is described as having four memory groups MG (MG1, MG2, MG3, and MG4). Each memory group MG includes four memory units MU. The number of memory groups MG mounted in the memory block MBLK and the number of memory units MU mounted in each memory group MG are not limited to those of the example illustrated in FIG. 3.

The memory block MBLK includes memory group controllers MCNT (MCNT1, MCNT2, MCNT3, and MCNT4) disposed on the input sides of the memory groups MG. The memory block MBLK also includes a memory group controller MG4 disposed on the output side of the memory group MCNT5 of the last stage.

Although not particularly limited, the size of each memory unit MU is 8 kwords × 128 bits (= 1 Mbits), and each memory unit MU inputs and outputs a 128-bit signal. The size of the memory group MG including four memory units MU is 32 kwords × 128 bits (= 4 Mbits). The size of the memory block MBLK including four memory groups MG is 128 kwords × 128 bits (= 16 Mbits).

In this embodiment, the switching unit of the shutdown mode, the sleep mode, and the active mode is the memory unit MU. The sleep mode is an example of a low power mode. The shutdown mode, the sleep mode, and the active mode may be switched in units of two memory units MU, or may be switched in units of columns obtained by further subdividing the memory units MU into a plurality of columns. Further, the shutdown mode, the sleep mode, and the active mode may be switched in units of memory groups MG.

For example, in each memory unit MU, the power consumption in the shutdown mode is approximately one-tenth the standby power in the active mode, and the power consumption in the sleep mode is approximately one-third the standby power in the active mode.

The memory group controller MCNT adjacent to the input side of a memory group MG outputs the control signal CMD, the address signal A, and the write data signal D to this memory group MG and the memory group controller MCNT on the output side of this memory group MG. A memory group MG outputs the read data signal Q to the memory group controller MCNT on the output side of this memory group MG. As illustrated in FIG. 3, the control line CMD and the address line A are wired in units of the memory groups MU, and are not wired across the plurality of memory groups MG. For this reason, it is possible to suppress an increase in the wiring load of the control line CMD and the address line A, and to also suppress an increase in the power consumption while suppressing an increase in the access time of the memory circuit 100.

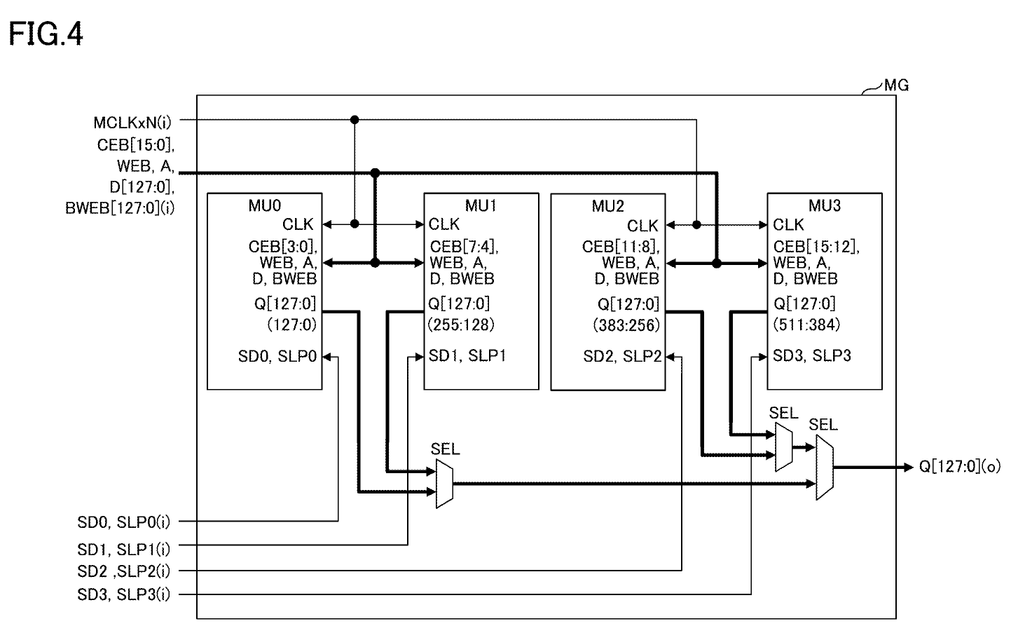

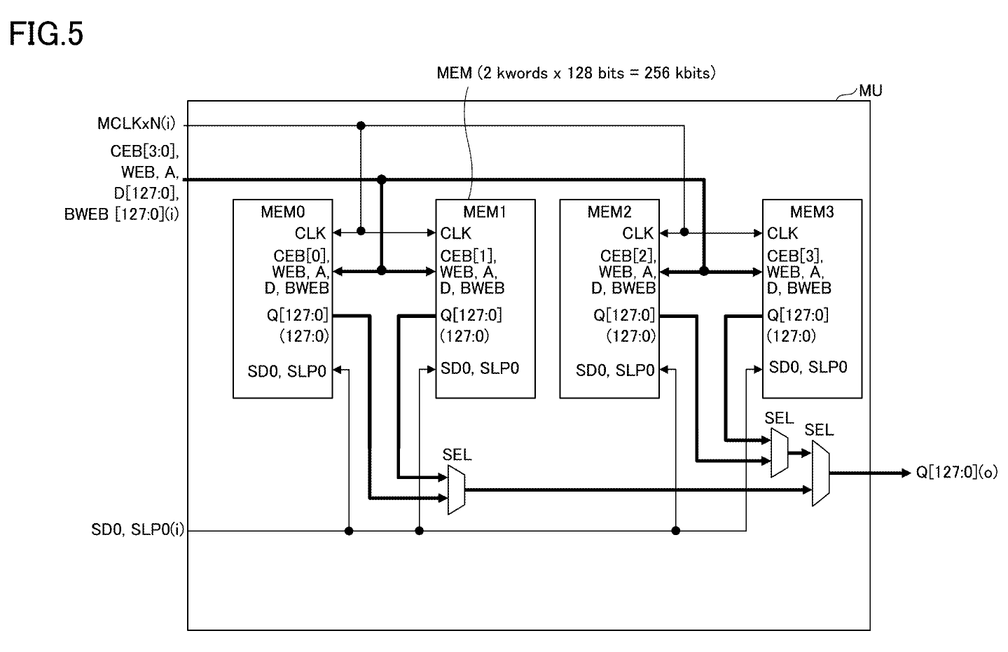

FIG. 4 illustrates an example of the configuration of the memory group MG illustrated in FIG. 3. The memory group MG will be described as having four memory units MU (MU0 through MU3). A label (i) added to the end of the signal name indicates that the signal is an input signal, and a label (o) added to the end of the signal name indicates that the signal is an output signal. The memory group MG receives a memory clock signal MCLKxN, 16 chip enable signals CEB[15:0], a write enable signal WEB, and a bit write enable signal BWEB[127:0] from the memory group controller MCNT as the control signal CMD illustrated in FIG. 3. The 16 chip enable signals CEB[15:0] are supplied to the memory units MU (MU0 through MU3) so that four chip enable signals CEB are supplied to the four memory units MU0 through MU3, respectively, and are used for the selection of the memory units MU and the four memories MEM (MEM0 through MEM3 illustrated in FIG. 5) in each memory unit MU illustrated in FIG. 3. In addition, the memory group MG receives a 128-bit write data signal D[127:0] from the memory group controller MCNT. The number of data terminals that receive the write data signal D in the memory group MG is one-fourth the number of data terminals that output the write data signal D in the memory controller 200.

A signal added with a label B at the end of the signal name indicates that the signal is a negative logic signal, and a signal without the label B added at the end of the signal names indicates that the signal is a positive logic signal. The bit write enable signal BWEB[127:0] refers to a signal for controlling the writing of the data signal in units of bits, and a bit of the bit write enable signal BWEB corresponding to the bit to be masked when writing the write data signal D is set to a high level.

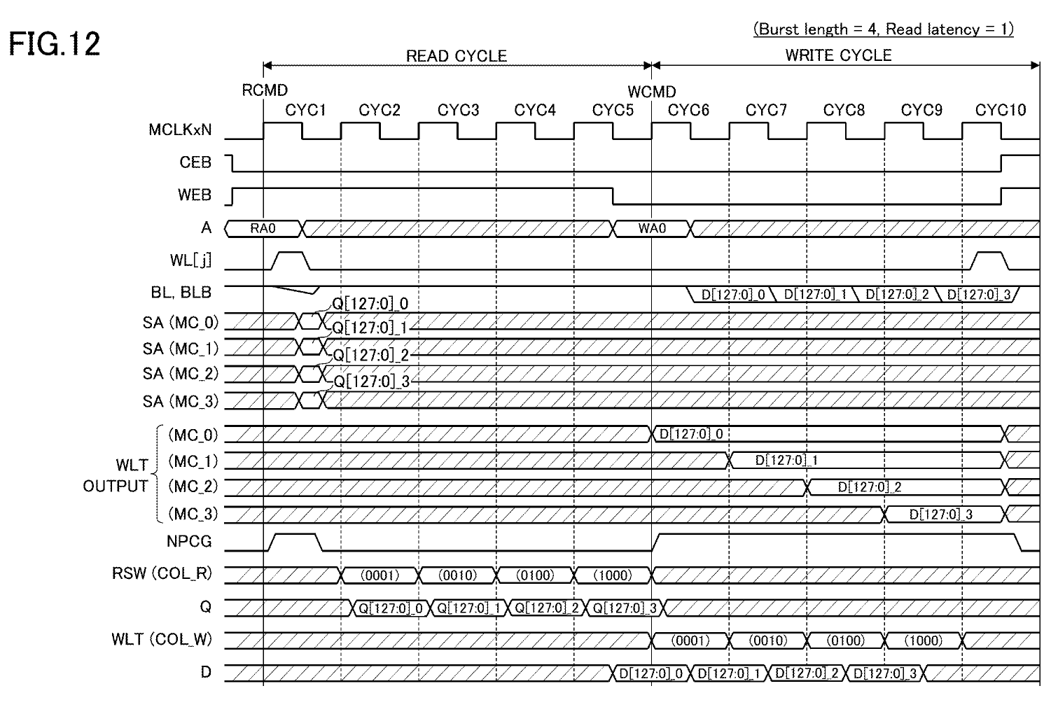

For example, the memory clock signal MCLKxN refers to a clock signal obtained by multiplying the frequency of the memory clock signal MCLK by four. A multiplication factor of the memory clock signal MCLKxN can be set equal to the number of memories MEM mounted on each memory unit MU. That is, the multiplication factor of the memory clock signal MCLKxN can be set equal to the number of read data signals Q continuously read from the memory unit MU by the read operation performed in response to one read command RCMD (FIG. 12). The multiplication factor of the memory clock signal MCLKxN can be set equal to the number of write data signals D continuously written to the memory unit MU by the write operation performed in response to one write command WCMD (FIG. 12).

The memory group MG receives the address signal A and the four 128-bit write data signals D[127:0] corresponding to the address signal A, and outputs four 128-bit read data signals Q[127:0]. The number of data terminals that output the read data signal Q in the memory group MG is one-fourth the number of data terminals that receive the read data signal Q in the memory controller 200.

The four 128-bit write data signals D are supplied to one of the four memory units MU0 through MU3 in the memory group MG. The memory group MG includes a plurality of selectors SEL that sequentially select one of the 128-bit read data signals Q output from the four memory units MU and output the selected read data signal Q to the memory group controller MCNT (not illustrated).

Further, the memory group MG receives a shutdown signal SD (SD0 through SD3) and a sleep signal SLP (SLP0 through SLP3) as the control signal CMD illustrated in FIG. 3 from the memory group controller MCNT (not illustrated). As described with reference to FIG. 3, in this embodiment, switching of the shutdown mode, the sleep mode, and the active mode is performed in units of the memory unit MU. For this reason, the shutdown signal SD and the sleep signal SLP are supplied to each memory unit MU.

FIG. 5 illustrates an example of the configuration of the memory unit MU illustrated in FIG. 4. The memory unit MU includes four memories MEM. The size of each memory MEM is 2 kwords × 128 bits (= 256 kbits). The memories MEM0 through MEM3 are enabled when the corresponding chip enable signals CEB[0] through CEB[3] have an active level (for example, a low level). Further, one memory MEM (one of MEM0 through MEM3) in the enabled state performs the read operation or the write operation according to the logic level of the write enable signal WEB.

The 128-bit read data signal Q [127:0] read from the memory MEM that performs the read operation is output as a read data signal Q[127:0](o) from the memory unit MU via one or more selectors SEL. The memory MEM that performs the write operation receives the 128-bit write data signal D[127:0] and writes the write data signal D[127:0] to a memory cell (not illustrated). For example, the memory MEM includes a plurality of SRAM memory cells, but may include memory cells of other volatile memories. The memory MEM may include a memory cell of a nonvolatile memory, such as a magnetoresistive random access memory (MRAM), a resistive random access memory (ReRAM), or the like. The number of memories MEM mounted in the memory unit MU is not limited to that of the example illustrated in FIG. 5.

The shutdown signal SD and the sleep signal SLP may be further subdivided. For example, a peak current can further be suppressed by supplying the shutdown signal SD and the sleep signal SLP for every two memories MEM.

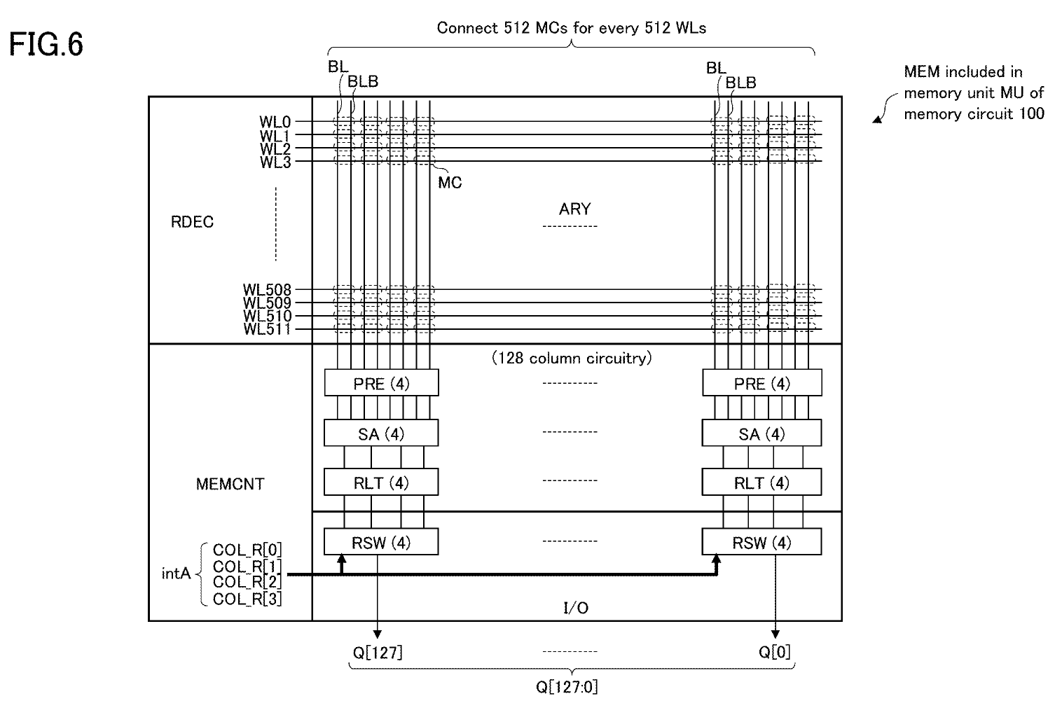

FIG. 6 illustrates an example of an internal configuration of the memory MEM included in the memory unit MU illustrated in FIG. 5. The memory MEM includes a row decoder RDEC, a memory array control circuit MEMCNT, a memory cell array ARY, precharge circuits PRE, sense amplifiers SA, read latches RLT, and a data input/output circuit I/O. The data input/output circuit I/O includes read switches RSW and buffers BUF (not illustrated). Hereinafter, the precharge circuits PRE, the sense amplifiers SA, the read latches RLT, the read switches RSW, and the buffers BUF are also referred to as a column circuit. The read latches RLT are an example of a data latch, and the read switches RSW are an example of a data selector.

For example, the memory cell array ARY includes 512 word lines WL extending in a horizontal direction illustrated in FIG. 6, 512 complementary bit line pairs BL and BLB extending in a vertical direction illustrated in FIG. 6, and a plurality of memory cells MC arranged in a matrix. Each memory cell MC is arranged at an intersection of the word line WL and the complementary bit line pair BL and BLB. Each word line WL is connected in common to 512 memory cells MC arranged in the horizontal direction.

The command signal CMD illustrated in FIG. 3 includes the read command RCMD and the write command WCMD. In response to the read command RCMD, the write enable signal (memory command signal) WEB illustrated in FIGS. 4 and 5 is controlled to a high level, and the memory MEM (MEM0 through MEM3) operates in the read mode. On the other hand, in response to the write command WCMD, the write enable signal (memory command signal) WEB illustrated in FIGS. 4 and 5 is controlled to a low level, and the memory MEM (MEM0 through MEM3) operates in the write mode.

As will be described with reference to FIG. 12, the data signals are simultaneously read from 512 memory cells MC on the word line WL selected based on one read command RCMD recognized from the control signal CMD (FIG. 3). The read data signals are transmitted to a total of 128 systems, where each system of the total of 128 systems is configured in units of four precharge circuits PRE, four sense amplifiers SA, four read latches RLT, and four read switches RSW. In a first clock cycle, the first one data signal is selected by the read switches RSW in units of four data signals, and output as the 128-bit read data signal Q[127:0].

In the second through fourth clock cycles, the next one data signal is sequentially selected by the read switches RSW in units of four data signals, and output as the 128-bit read data signal Q[127:0]. Finally, 512 read data signals Q are output in four clock cycles. FIG. 6 illustrates circuits used during the read operation, and illustration of circuits used only during the write operation is omitted.

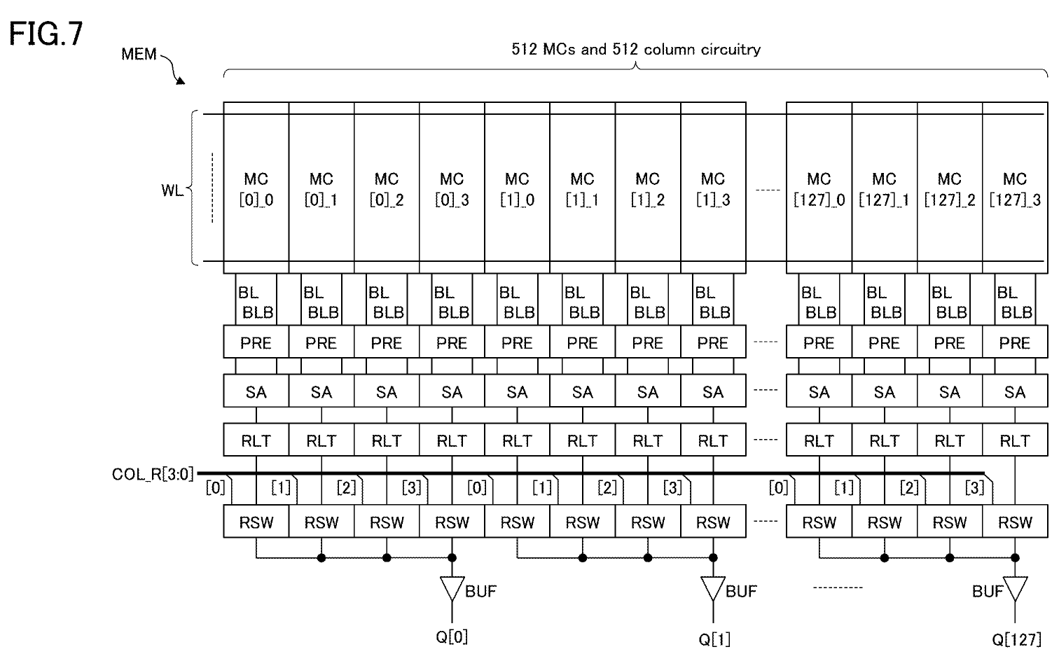

FIG. 7 illustrates the read operation by column circuitry illustrated in FIG. 6 from a viewpoint of individual read data signals. In FIG. 7, the 512 memory cells MC connected to the word line WL are illustrated as MC[k]_0, MC[k]_1, MC[k]_2, and MC[k]_3 (where k = 0 to 127) in units of four memory cells. The precharge circuit PRE, the sense amplifier SA, and the read latch RLT are provided in a one-to-one relationship with respect to the bit line pair BL and BLB connected to the memory cell MC, and all data simultaneously read to the bit line pair BL and BLB are latched by the read latches RLT via the sense amplifiers SA.

During the read operation, after the precharging of the bit line pair BL and BLB by the precharge circuit PRE is stopped, the data signals are read from the 512 memory cells MC connected to one word line WL selected by the row decoder RDEC, and amplified by the sense amplifiers SA. The data signals amplified by the sense amplifiers SA are latched by the read latches RLT.

Thereafter, the 512 data signals latched by the read latches RLT are selected 128 data signals at a time for every read cycle by four column read signals COL_R[3:0] generated by the memory array control circuit MEMCNT and supplied to the read switches RSW. In the first clock cycle, the read switches RSW to receive the column read signal COL_R[0] are selected, and the 128 data signals read from the memory cells MC[k]_0 (where k = 0 to 127) are output as the read data signals Q[k] (where k = 0 to 127) via the buffers BUF.

In the second through fourth clock cycles, the read switches RSW to receive the column read signals COL_R[1], COL_R[2], and COL_R[3] are sequentially selected. Further, the 128 data signals read from the memory cells MC[k]_1, MC[k]_2, and MC[k]_3 for every clock cycle are output as the read data signals Q[k] via the buffers BUF. Finally, all of the data held in the 512 memory cells MC are output using four clock cycles. Although this embodiment describes a case where the number of the column read signals is four, the number of the column read signals is not limited to four, and may be eight or sixteen. The column read signals COL_R[0] through COL_R[3] are generated by the memory array control circuit MEMCNT regardless of the external address signal supplied to the memory MEM in FIG. 6.

In order to prevent a hazard from occurring in each bit of the read data signal Q[127:0] when the column read signal COL_R[3:0] is switched, a latch may be disposed between each read switch RSW and the buffer BUF, for example.

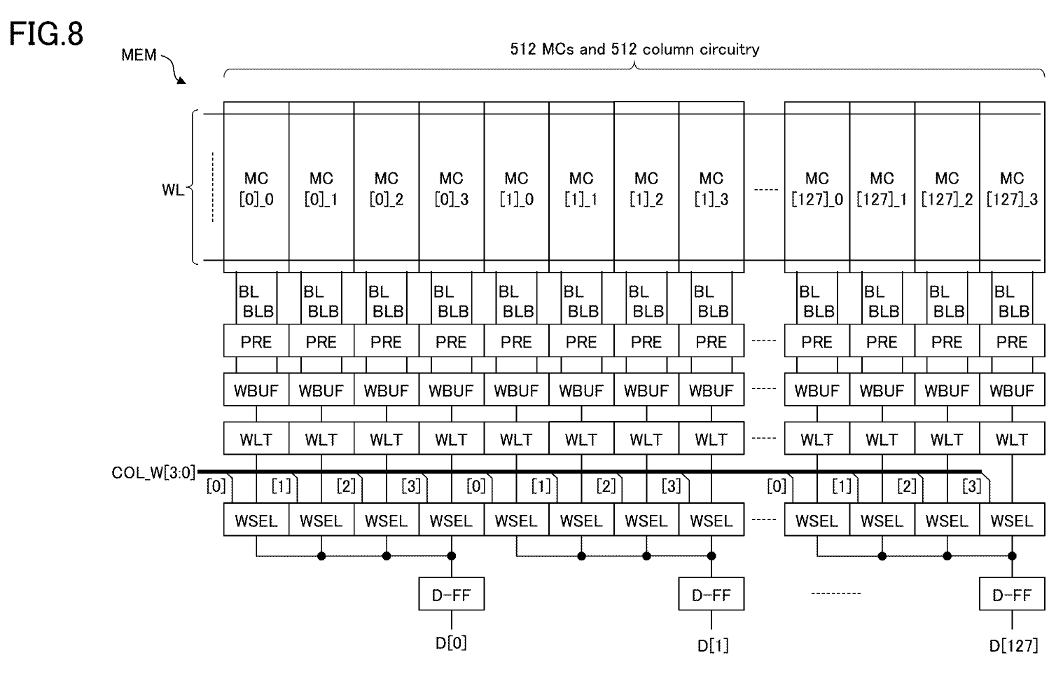

FIG. 8 illustrates the write operation by the column circuitry illustrated in FIG. 6 from a viewpoint of individual write data signals. During the write operation, flip-flop circuits D-FF, write selectors WSEL, write latches WLT, and write buffers WBUF are used in addition to the circuits illustrated in FIG. 6. The write selectors WSEL are an example of a data selector, and the write latches WLT are an example of a data latch.

The flip-flop circuits D-FF are provided in correspondence with each bit of the write data signal D [127:0]. Each bit data of the 128 write data signals D is selected by one of four write selectors WSEL that receive four column write signals COL_W[3:0] sequentially generated by the memory array control circuit MEMCNT. The write latches WLT, the write buffers WBUF, and the precharge circuits PRE are provided in a one to-one relationship with respect to the bit line pair BL and BLB. The write latches WLT are selectively connected to the outputs of the flip-flop circuits D-FF via the write selectors WSEL in each write cycle. The write buffers WBUF drive the bit line pair BL and BLB according to the data of the write latches WLT. The precharge circuits PRE precharge the bit line pair BL and BLB.

In the first clock cycle, the write data signal is latched in the write latch WLT connected to the system of the memory cell MC[k]_0 (where k = 0 to 127) via the write selector WSEL selected by the column write signal COL_W[0]. In the second through fourth clock cycles, the write selectors WSEL that receive the column write signals COL_W[1], COL_W[2], and COL_W[3] are selected. Then, the write data signals are sequentially latched in the write latches WLT connected to one of the systems of the memory cells MC[k]_1, MC[k]_2, and MC [k]_3 (where k = 0 to 127), respectively, via the write selectors WSEL selected for every clock cycle.

After the write data signals are latched in all of the write latches WLT connected to the memory cells MC[k]_0, MC[k]_1, MC[k]_2, and MC[k]_3 over four clock cycles, the latched write data signals are written in 512 memory cells MC selected by the word line WL via the write buffers WBUF. In a case where the write cycle is performed in four cycles, the corresponding write buffers WBUF are enabled in each clock cycle, and the data of the bit line pair BL and BLB are sequentially determined. In a clock cycle next to the completion of the fourth clock cycle, a desired word line WL is activated, and all of the write data are written to the memory cells MC. This can suppress unwanted flow of charge and discharge currents to the bit line pair BL and BLB due to a pseudo read when the word line WL is activated.

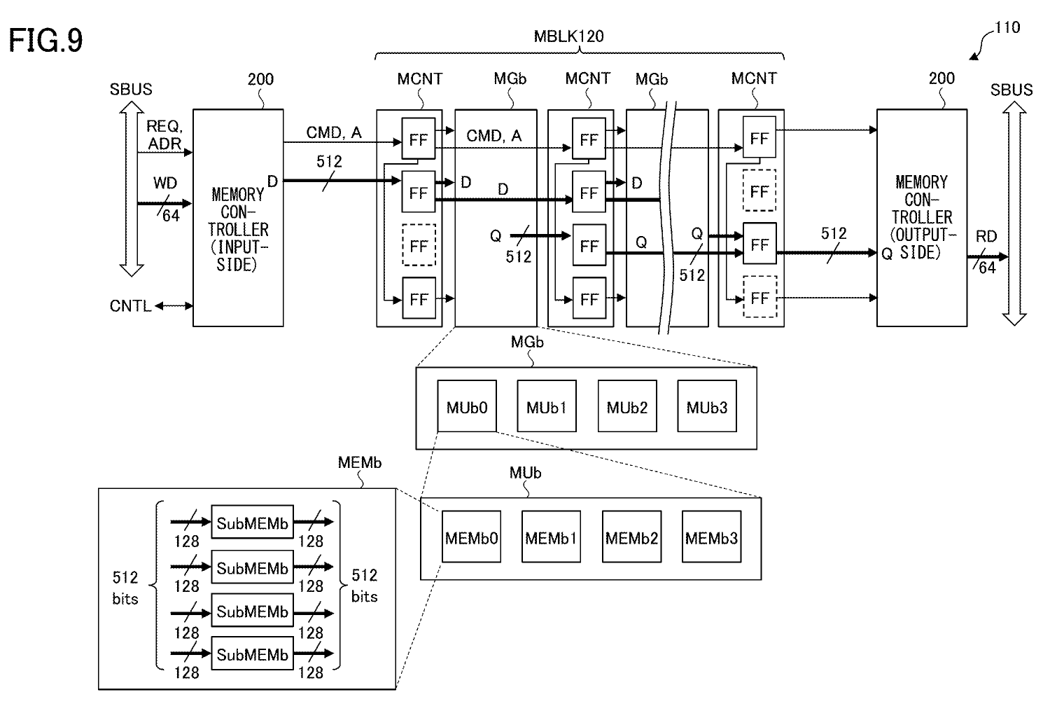

FIG. 9 illustrates an example of a memory circuit 110 including a memory block (MBLK) 120 that receives a 512-bit write data signal D from the input-side memory controller 200 and outputs a 512-bit read data signal Q to the output-side memory controller 200. A detailed description of constituent elements that are the same as the constituent elements illustrated in FIG. 1 will be omitted. The memory circuit 110 illustrated in FIG. 9 does not have the data converters PSCNV and SPCNV illustrated in FIG. 1. The memory circuit 110 has the same configuration as the memory circuit 100 illustrated in FIG. 1 except that the 512-bit write data signal D is simultaneously transmitted in the MBLK 120 during a write operation, the 512-bit read data signal Q is simultaneously transmitted in the MBLK 120 during a read operation, and memory groups MGb are provided in place of the memory groups MG illustrated in FIG. 1. Each memory group MGb includes four memory units MUb (MUb0 through MUb3), and each memory unit MUb includes four memories MEMb (MEMb0 through MEMb3). Each memory MEMb has sub-memories SubMEMb. 128 bits of data obtained by dividing the 512-bit data into four data portions are read from and written to sub-memories SubMEMb, respectively.

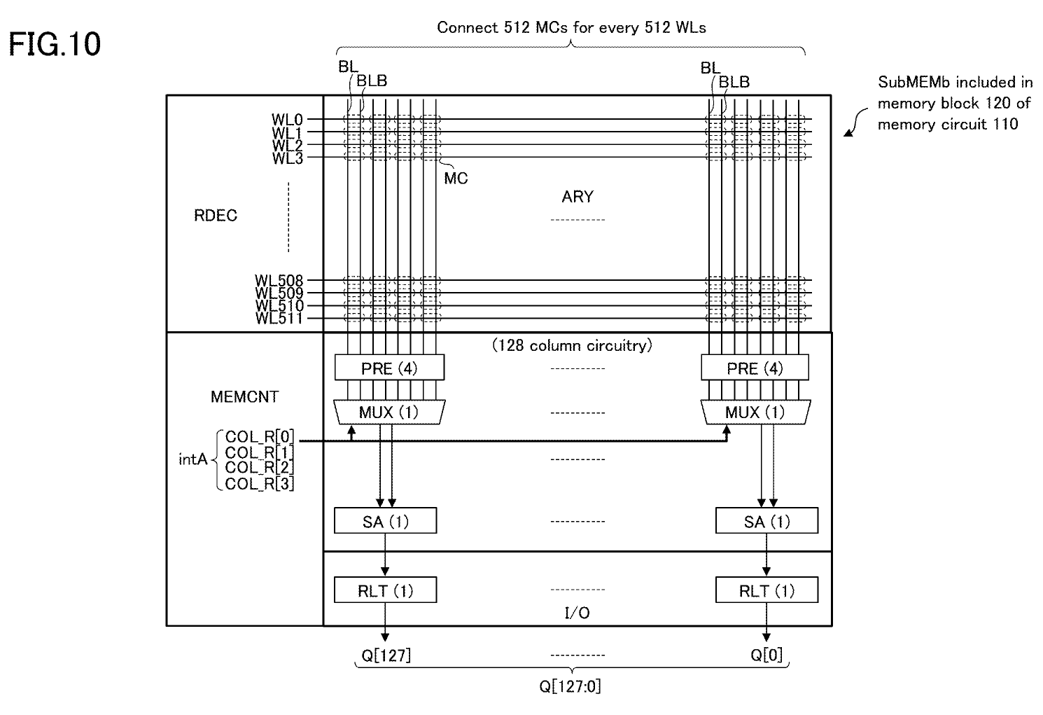

FIG. 10 illustrates an example of an internal configuration of the sub-memory SubMEMb illustrated in FIG. 9. The memory MEM illustrated in FIG. 6 can access 512 bits in 128 bits × 4 clock cycles in response to one memory access request, whereas the sub-memory SubMEMb illustrated in FIG. 10 accesses 128 bits in one data access in response to one memory access request. For this reason, the memory access request is performed four times to access 512 bits by a data access which corresponds to accessing 128 bits 4 times, or the data width is set to 512 bits as illustrated in FIG. 9 and four systems of sub-memories SubMEMb are prepared in parallel (vertically arranged in FIG. 9) to access 512 bits by one data access.

Further, the bit line pair BL and BLB, the precharge circuit PRE, the sense amplifier SA, the read latch RLT, and the read switch RSW are configured in a one-to-one relationship in FIG. 6, whereas the bit line pair BL and BLB and the precharge circuit PRE are configured in a four-to-one relationship with respect to the sense amplifier SA and the read latch RTL via a multiplexer MUX in FIG. 10. Further, when the operations of the word line WL and the bit line pair BL and BLB are compared between the memory MEM illustrated in FIG. 6 and the sub-memory SubMEMb illustrated in FIG. 10, the two differ in that the word line WL and the bit line pair BL and BLB of the memory MEM illustrated in FIG. 6 are activated and deactivated only once in a case where 512 bits of data are output for every four clock cycles, whereas the word line WL and the bit line pair BL and BLB of the sub-memory SubMEMb illustrated in FIG. 10 are repeatedly activated and deactivated for every four clock cycles. The configuration illustrated in FIG. 10 differs from the configuration illustrated in FIG. 6 in that the multiplexers MUX in FIG. 10 are arranged between the precharge circuits PRE and the sense amplifiers SA in FIG. 6 and the read switches RSW in FIG. 6 are not provided, but the multiplexers MUX may be configured by the read switches RSW.

Although not illustrated, the memory array control circuit MEMCNT decodes an address signal A input from the outside of the sub-memory SubMEMb to set one of four decoded signals COL_R[3:0] to an active level. The multiplexer MUX is provided for every four memory cells MC. The multiplexers MUX input, to the sense amplifiers SA, 128 pairs (128 bits) of data signals selected from 512 pairs (512 bits) of data signals which are output from the corresponding memory cells MC to the bit line pairs BL and BLB. Each sense amplifier SA differentially amplifies the input data signal and outputs the amplified data signal to the read latch RLT. Hence, a 128-bit read data signal Q[127:0] is output via the read latch RLT.

In the memory circuit 110 illustrated in FIG. 10, only the 128 bits of the 512-bit data signal read from the memory cells MC during the read operation are output as the read data signal Q[127:0], and the remaining 384 bits of 512-bit data signal are not output. During the read operation and the write operation of the memory circuit, such as the SRAM or the like, the power of charging and discharging the bit line pair BL and BLB is dominant with respect to the entire power consumption. For this reason, the power consumption per bit of the data signal read during the read operation of the memory circuit 110 is approximately four times the power consumption per bit of the data signal read during the read operation of the memory MEM illustrated in FIG. 6, for example, resulting in unnecessary power consumption.

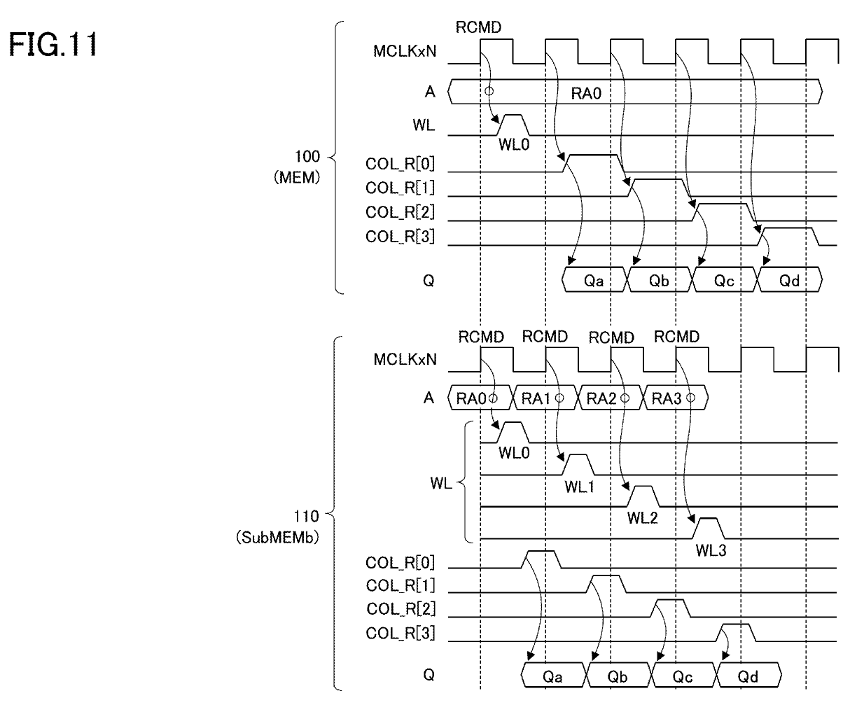

FIG. 11 illustrates an outline of operation timings of read operations of the memory MEM included in the memory unit MU of the memory circuit 100 illustrated in FIG. 6 and the sub-memory SubMEMb included in the MBLK 120 of the memory circuit 110 illustrated in FIG. 10. For example, the memory MEM illustrated in FIG. 6 and the sub-memory SubMEMb illustrated in FIG. 10 operate in synchronism with the memory clock signal MCLKxN.

The memory unit MU (FIG. 5) of the memory circuit 100 decodes the upper 2 bits of the address signal A (= RA0) received together with the read command RCMD to generate a chip enable signal CEB[3:0] (FIG. 5), and selects one memory MEM of the memory MEM0, the memory MEM1, the memory MEM2, and the memory MEM3. The row decoder RDEC in the selected memory MEM decodes 9 bits from the third bit to the eleventh bit in the upper bits of the address signal RA0, selects a word line WL0 from the 512 word lines WL, for example, and reads out the 512-bit data signal from the memory cell array ARY.

Thereafter, the memory MEM decodes the lower 2 bits of the address signal RA0 in the memory array control circuit MEMCNT, sequentially generates a column read signal COL_R[3:0], and sequentially outputs the 128-bit data signal in four separate segments as read signals Qa, Qb, Qc, and Qd. The output data is output to a read data terminal Q[127:0](o) of the memory unit MU via the selector SEL (FIG. 5) in the memory unit MU. Accordingly, all of the data signals read from the memory MEM in response to one read command RCMD can be output to the outside of the memory circuit 100. In the case of the memory MEM, the column read signal COL_R[3:0] is generated by the memory array control circuit MEMCNT, and thus, the lower 2 bits of the address signal RAn described above become unnecessary.

In the case of the sub-memory SubMEMb of the memory circuit 110, four address signals A (= RA0 through RA3) need to be sequentially generated with respect to one read command RCMD. The sub-memory SubMEMb sequentially selects the word lines WL0 through WL3 corresponding to the address signals RA0 through RA3, and selects the 128-bit data signal of the 512-bit data signal read from the memory cells MC connected to the selected word lines WL0 through WL3 by the column read signal COL_R[3:0]. The MBLK 120 sequentially outputs the 128-bit read data signals Qa, Qb, Qc, and Qd for every read command RCMD. The same address signal A may be received together with the read command RCMD, and the same word line WL may be selected four times. In the case of the sub-memory SubMEMb, the column read signal COL_R[3:0] is generated by decoding the lower 2 bits of the external address RAn.

FIG. 12 illustrates an example of operation timings of the read operation and the write operation of the memory MEM illustrated in FIGS. 6, 7, and 8. During the read operation and the write operation illustrated in FIG. 12, it is assumed that a burst length is 4, and a read latency is 1. In FIG. 12, a label [j] added to the word line WL indicates an arbitrary number.

At a beginning of the timing chart, during a high-level period of the chip enable signal CEB, the memory MEM is set to a standby state, and all of the word lines WL are deactivated to a low level. The precharge circuit PRE receives a precharge signal NPCG which has a low level is an enable state, and precharges the bit line pair BL and BLB to a high level.

The memory MEM receives a low-level (L) chip enable signal CEB and a high-level (H) write enable signal WEB together with the address signal A (= RA0) during a clock CYC1, and recognizes the read operation. A read cycle occurs five clock cycles after the read operation is recognized.

The memory MEM activates the word line WL indicated by the address signal RA0 to a high level. The memory MEM controls a precharge signal NPCG to a high level during an activation period of the word line WL, to stop the precharge operation of the bit line pair BL and BLB by the precharge circuit PRE, and set the bit line pair BL and BLB to a high level floating state. Then, the memory MEM activates the word line WL to read the data signals from 512 memory cells MC to 512 bit line pairs BL and BLB.

The 512 data signals read to the bit line pair BL and BLB do not have sufficiently large amplitudes. For this reason, the memory MEM differentially amplifies the 512 data signals by 512 sense amplifiers SA, respectively. The memory MEM latches all of the 512 data signals amplified by the sense amplifiers SA in the read latches RLT (FIG. 7) corresponding one-to-one to the sense amplifiers SA. After latching the 512 data signals in the read latches RLT, the memory MEM deactivates the word line WL and stops the operation of the sense amplifiers SA. In addition, the memory MEM causes a transition of the precharge signal NPCG to a low level to precharge the bit line pair BL and BLB to the high level.

In clock cycles CYC2 through CYC5, the memory array control circuit MEMCNT sequentially generates the column read signal COL_R[3:0], to sequentially output the 512-bit data signals read from the 512 memory cells MC and held in the read latches RLT, 128 bits at a time, via the read switches RSW (FIG. 7). The data signals sequentially output from the read switches RSW are output via the buffers BUF as the read data signal Q, and the read cycle ends. In FIG. 12, the memory MEM sequentially generates four column read signals COL_R[3:0] and outputs the read data signal Q in four clock cycles, but the read data signal Q may be output in eight clock cycles or sixteen clock cycles. In FIG. 12, the clock cycle in which the read data is first output is the cycle CYC2, that is, a read latency is assumed to be 1, but the read latency may be 2 or 3, for example.

In the write cycle, the memory MEM receives the low-level (L) chip enable signal CEB and the low-level (L) write enable signal WEB together with the address signal A (= WA0) in a clock cycle CYC6, and recognizes the write operation. Five clock cycles after the recognition of the write operation are the write cycle. When the memory MEM recognizes the write cycle in the clock cycle CYC5, the memory MEM controls the precharge signal NPCG to the high level to release the bit line pair BL and BLB from the precharged state.

The memory MEM sequentially generates the column write signal COL_W[3:0] in the clock cycles CYC6 through CYC9. The memory MEM selects 128 bits of the write data signal D by the write selectors WSEL (FIG. 8) in each clock cycle in synchronism with each column write signal COL_W[3:0], and sequentially latches the selected bits of the write data signal D in the corresponding write latches WLT. Each write latch WLT sequentially outputs the latched data signal to the write buffer WBUF (FIG. 8), to transmit the data signal D to the corresponding bit line pair BL and BLB, and determine the data of the 512 bit line pairs BL and BLB.

In a clock cycles CYC10, the memory MEM activates the word line WL corresponding to the address signal A (= WA0), and writes logic values of the 512-bit data signal transmitted to each bit line pair BL and BLB into the memory cells MC. After writing the data to the memory cells MC, the memory MEM deactivates the word line WL to a low level, sets the precharge signal NPCG to a low level to precharge the bit line pair BL and BLB, and the write cycle ends.

In FIG. 12, four column write signals COL_W[0:3] are sequentially generated in the write cycle, and the write data signal D is latched in the write latches WLT and written to the memory cells MC in four clock cycles, but the write data signal D may be latched in the write latches WLT in eight clock cycles or sixteen clock cycles. Further, in FIG. 12, the data write cycle to the memory cells MC is only the clock cycle after the write data signal D is latched in all of the write latches WLT, but the data write cycle to the memory cells MC may be the clock cycle in which the last data is latched, or may be two clock cycles after the last data is latched. In addition, the number of cycles in which the data is written to the memory cells MC is not limited to one clock cycle, and may be two clock cycles or three clock cycles.

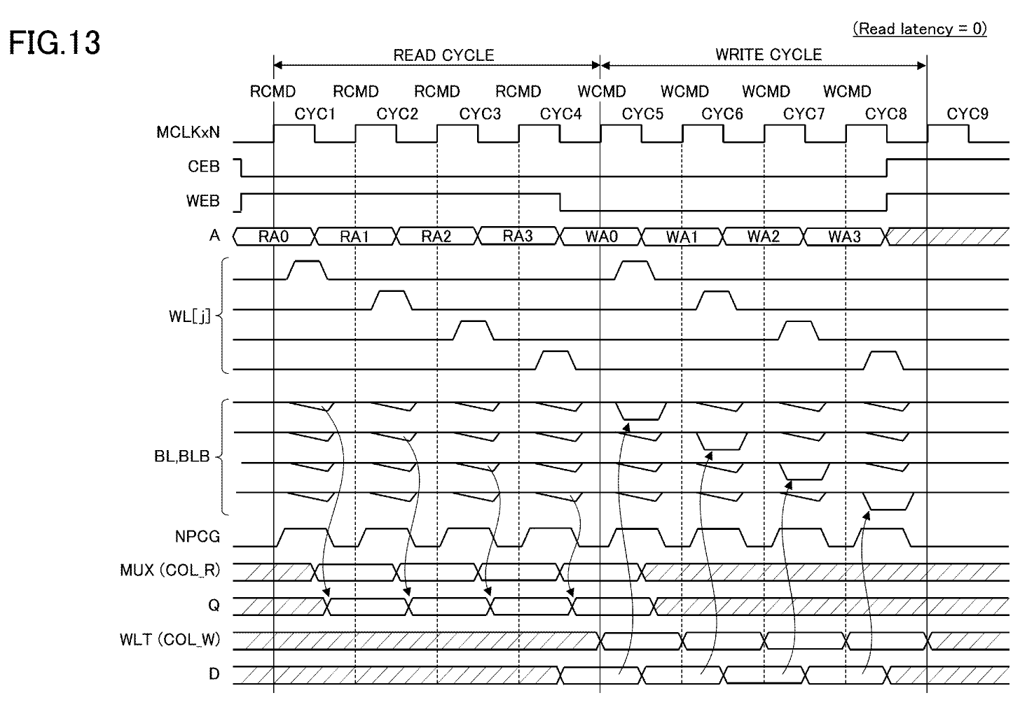

FIG. 13 illustrates an example of operation timings of the read operation and the write operation of the sub-memory SubMEMb illustrated in FIG. 10. A detailed description of the operation that is the same as that illustrated in FIG. 12 will be omitted. Waveforms of the memory clock signal MCLKxN, the chip enable signal CEB, and the write enable signal WEB are the same as those illustrated in FIG. 12.

In the read cycle, the sub memory SubMEMb receives the address signal A (RA0 through RA3) together with the read command RCMD for every four clock cycles CYC1 through CYC4, and selects the word line WL corresponding to the address signals RA0 through RA3. Even in a case where the same word line WL is selected in each of the clock cycles CYC1 through CYC4, it is necessary to repeat the activation and deactivation of the word line WL for every clock cycle. As a result, the reading of the data signal and the precharge operation are also repeated for the 512 bit line pairs BL and BLB.

The sub-memory SubMEMb reads out the data signals from the 512 memory cells MC to the 512 bit line pairs BL and BLB every time the word line WL is selected. The MBLK 120 decodes 2 bits assigned to the address signal A to generate the column read signal COL_R[3:0]. The 128-bit data signals of the 512-bit data signal read from the memory cells MC are sequentially selected by the column read signal COL_R[3:0] via the multiplexers MUX at every clock cycle from the clock cycles CYC1 through CYC4, and amplified by the sense amplifiers SA (FIG. 10).

The sub-memory SubMEMb sequentially outputs the 128-bit read data signal Q for every read operation, and the read cycle ends. A 384-bit data signal of the 512 data signals read from the memory cells MC are not output from the memory circuit 110.

In the write cycle, the sub-memory SubMEMb receives the address signal A (WA0 through WA3) and the 128-bit write data signal D together with the write command WCMD every four clock cycles CYC5 through CYC8. The sub-memory SubMEMb once latches the 128-bit write data signal D, and thereafter generates the column write signal COL_W[0:3] by decoding 2 bits included in the address signal A.

The sub-memory SubMEMb selects the word line WL corresponding to the address signals WA0 through WA3, and reads out the 512 bits of data held in the memory cells MC to the bit line pair BL and BLB as the data signal. On the other hand, the latched 128-bit write data selectively drives the write buffer in response to the column write signal COL_W[0:3], and overwrites the data read to the corresponding bit line pair BL and BLB, to write the data to the memory cells MC. Of the 512 bits of read data, 128 bits are overwritten, and the remaining 384 bits of read data are not used and are precharged when the word line WL is deactivated. The same operation is repeated in four clock cycles of the write cycles CYC5 through CYC8 while sequentially activating the column write signal COL_W[0:3].

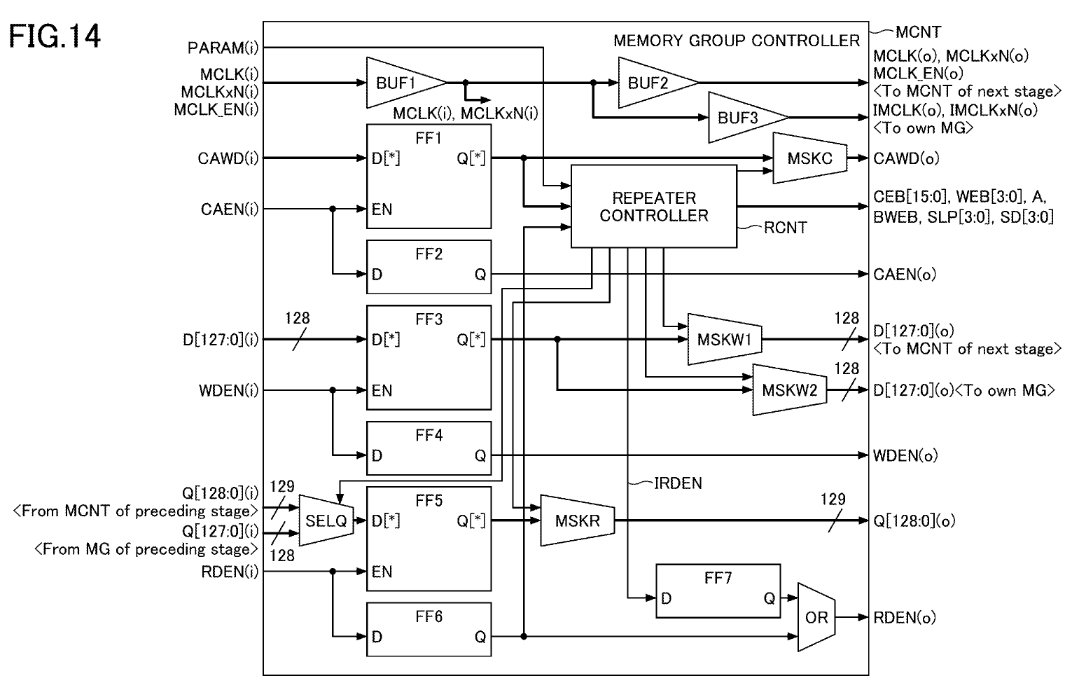

FIG. 14 illustrates an example of a configuration of the memory group controller MCNT illustrated in FIG. 1. The memory group controller MCNT includes a plurality of flip-flop circuits FF (FF1, FF2, FF3, FF4, FF5, FF6, and FF7), a repeater controller RCNT, and a plurality of mask circuits MSK (MSKC, MSKW1, MSKW2, and MSKR). The flip-flop circuit FF having a bold signal line connected thereto is configured by a plurality of flip-flop circuits. A label (i) added to the end of the signal name indicates that the signal is an input signal, and a label (o) added to the end of the signal name indicates that the signal is an output signal.

The memory clock signals MCLK, MCLKxN, and the clock enable signal MCLK_E are supplied to a buffer BUF1. The memory clock signals MCLK and MCLKxN and the clock enable signal MCLK_E output from the buffer BUF1 are output to the memory group controller MCNT of the next stage via a buffer BUF2. In addition, the memory clock signals MCLK and MCLKxN output from the buffer BUF1 are output to the memory group MG (the memory group MG of the next stage) of the memory group controller MCNT of the next stage as memory clock signals IMCLK and IMCLKxN via a buffer BUF3.

The memory clock signals MCLK and MCLKxN are also transmitted to each synchronization circuit in the memory group controller MCNT via the buffer BUF1. That is, each synchronization circuit in the memory group controller MCNT operates in synchronism with the memory clock signal MCLK or the memory clock signal MCLKxN. For example, the memory clock signal MCLK is used to control a command address signal CAWD (the control signal CMD and the address signal A), and the memory clock signal MCLKxN is used to control the write data signal D and the read data signal Q.

The flip-flop circuit FF1 holds and outputs the received command address signal CAWD when the command address enable signal CAEN has the active level. The command address enable signal CAEN is output from the memory controller 200 together with the control signal CMD and the address signal A. The flip-flop circuit FF2 transfers the command address enable signal CAEN received from the memory controller 200 or the memory group controller MCNT of the preceding stage to the memory group controller MCNT of the subsequent stage.

The flip-flop circuit FF3 holds and outputs the received 128-bit write data signal D[127:0] when the write data enable signal WDEN has the active level. The write data enable signal WDEN is output from the memory controller 200 together with the write data signal D. The flip-flop circuit FF4 transfers the write data enable signal WDEN received from the memory controller 200 or the memory group controller MCNT of the preceding stage to the memory group controller MCNT of the subsequent stage.

The selector SELQ selects the 128-bit read data signal Q[127:0] read from the memory group MG of the preceding stage or the 129-bit read data signal Q[128:0] transferred from the memory group controller MCNT of the preceding stage according to the level of the control signal from the repeater controller RCNT. The selector SELQ outputs the selected read data signal Q to the flip-flop circuit FF5. The selector SELQ can operate the memory group controller MCNT as a repeater circuit and transfer the read data signal Q to the memory controller 200, regardless of the position of the memory group MG which performs the read operation and outputs the read data signal Q.

The flip-flop circuit FF5 operates when the read data enable signal RDEN received from the memory group controller MCNT of the preceding stage has the active level. For example, the active level of the read data enable signal RDEN is a high level. The read data enable signal RDEN is output from the memory group controller MCNT of either the preceding stage or a stage preceding the preceding stage.

The flip-flop circuit FF5 receives and holds the 129-bit read data signal Q[128:0] (1 bit is the last information) from the memory group controller MCNT of the preceding stage or the 128-bit read data signal Q[127:0] from the memory group MG of the preceding stage, via the selector SELQ. The flip-flop circuit FF5 outputs the held read data signal Q to the mask circuit MSKR.

The memory group MG of the preceding stage refers to a memory group MG arranged adjacent to the input-side memory controller 200 with respect to the memory group controller MCNT of interest. The operation of the memory group MG of the preceding stage is controlled by the memory group controller MCNT of the stage preceding the memory group controller MCNT of interest.

The flip-flop circuit FF6 holds the read data enable signal RDEN received from the memory group controller MCNT of the preceding stage, and transfers the read data enable signal RDEN to the memory group controller MCNT of the subsequent stage via an OR circuit OR. The memory group controller MCNT of the first stage does not receive the read data signal Q from the memory group MG. The memory group controller MCNT of the second stage does not receive the read data signal Q from other memory group controllers MCNT.

The flip-flop circuit FF7 receives and holds the read data enable signal IRDEN output from the repeater controller RCNT, and outputs the read data enable signal DATA to the OR circuit OR. The read data enable signal IRDEN is set to the active level in a case where the signal is read from a memory group MG of a memory group controller MCNT of a stage subsequent to the memory group controller MCNT that includes the repeater controller RCNT described above.

The repeater controller RCNT controls the operation of the repeater controller RCNT itself, and also controls the operation of the memory group MG of the subsequent stage. The memory group MG of the subsequent stage refers a memory group MG arranged adjacent to the memory group controller MCNT of interest at a position closer to the output-side memory controller 200 than to the input-side memory controller 200, and is the memory group MG whose operation is controlled by the memory group controller MCNT of interest.

The repeater controller RCNT operates based on a logic value of a parameter signal PARAM output from the memory controller 200 for every memory group controller MCNT. The memory controller 200 outputs the parameter signal PARAM having a logic value corresponding to the position of the memory group controller MCNT to the corresponding memory group controller MCNT. That is, the parameter signal PARAM has a logic value unique for every memory group controller MCNT, and indicates a stage number or a stage position of the memory group controller MCNT among the plurality of stages.

The repeater controller RCNT can detect the memory group MG that is to perform the write operation or the read operation by decoding the command address signal CAWD (the control signal CMD and the address signal A) from the flip-flop circuit FF1. In a case where the repeater controller RCNT determines the write operation of the memory group MG of the subsequent stage, the repeater controller RCNT outputs a low-level (L) chip enable signal CEB, a low-level (L) write enable signal WEB, the address A, and the bit write enable signal BWEB to the memory group MG of the subsequent stage. The chip enable signal CEB and the write enable signal WEB are generated in correspondence with each of the four memory units MU in the memory group MG of the subsequent stage.

In a case where the repeater controller RCNT determines the read operation of the memory group MG of the subsequent stage, the repeater controller RCNT outputs a low-level (L) chip enable signal CEB, a high-level (H) write enable signal WEB, and the address A to the memory unit MU which is a read target. In a case where the repeater controller RCNT determines a transition of the memory group MG of the subsequent stage to the sleep mode or the shutdown mode, the repeater controller RCNT outputs the sleep signal SLP and the shutdown signal SD having a predetermined logic level to the memory unit MU to be controlled. The sleep signal SLP and the shutdown signal SD are generated in correspondence with each of the four memory units MU in the memory group MG of the subsequent stage.

In a case where the repeater controller RCNT determines a deactivation or exit of the memory group MG of the subsequent stage from the sleep mode or the shutdown mode, the repeater controller RCNT outputs a low-level (L) sleep signal SLP and a low-level (L) shutdown signal SD to the memory group MG of the subsequent stage. The deactivation or exit from the sleep mode or the shutdown mode occurs when performing the write operation or the read operation.

For example, during the shutdown mode, the sleep signal SLP is set to the low level and the shutdown signal SD is set to the high level. During the sleep mode, the sleep signal SLP is set to the high level and the shutdown signal SD is set to the low level. During the active mode, the sleep signal SLP and the shutdown signal SD are both set to the low level.

When activating the memory circuit 100, the sleep signal SLP is set to the low level and the shutdown signal SD is set to the high level, and all of the memory groups MG are set to the shutdown mode. Thereafter, only the memory unit MU to be operated is caused to make a transition from the shutdown mode to the active mode, to perform the write operation or the read operation. Further, in a case where there is no access for a predetermined period in the active mode, the memory unit MU in the active mode makes a transition to the sleep mode under the control of the corresponding memory group controller MCNT. The predetermined period for determining the transition from the active mode to the sleep mode can be varied by a set value of the register of the memory state manager 212 illustrated in FIG. 2.

In addition, the memory unit MU in the sleep mode or the active mode can make a transition to the shutdown mode based on an instruction from the memory controller 200. Accordingly, the memory unit MU which performs the write operation or the read operation is set to the active mode, and the other memory units MU are set to the sleep mode or the shutdown mode. By minimizing the number of memory units MU set to the active mode, the power consumption of the memory circuit 100 can be reduced.

The repeater controller RCNT detects the read data signal Q output from the memory group MG of the preceding stage or the stage preceding the preceding stage, based on the control signal CMD and the address signal A received from the memory group controller MCNT of the preceding stage. In a case where the read data signal Q is output from the memory group MG of the preceding stage, the repeater controller RCNT selects the read data signal Q from the memory group MG of the preceding stage by the selector SELQ. In a case where the read data signal Q is output from the memory group MG of the stage preceding the preceding stage, the repeater controller RCNT selects the read data signal Q transferred from the memory group controller MCNT of the preceding stage by the selector SELQ.

The repeater controller RCNT cancels a mask state of the mask circuit MSKR to a mask inactive state when the read data enable signal RDEN has an active level, and sets the mask circuit MSKR to the mask state when the read data enable signal RDEN has an inactive level. Accordingly, when the memory group controller MCNT receives the 128-bit read data signal Q by the read operation performed by the memory group MG on the preceding stage side of the memory group controller MCNT, the memory group controller MCNT can relay and transfer the read data signal Q to the memory group controller MCNT of the subsequent stage.

Moreover, in a case where the repeater controller RCNT does not receive the read data signal Q from the preceding stage side, the repeater controller RCNT suppresses the transfer of the inactive read data signal Q from the preceding stage side to the memory group controller MCNT of the subsequent stage. Accordingly, it is possible to suppress the transfer of the inactive read data signal Q between the memory group controller MCNT on the preceding stage side of the memory group MG which performs the read operation and the memory group controller MCNT of a further preceding stage, and to reduce the power consumption during the read operation.

The repeater controller RCNT detects the read data signal Q once output from the memory group controller MCNT's own memory group MG, based on the control signal CMD, the address signal A, and the command address signal CAWD including the additional information received from the memory group controller MCNT of the preceding stage. In a case where the read data signal Q is output from the memory group MG of the memory group controller MCNT of the stage subsequent to the memory group controller MCNT that includes the repeater controller RCNT described above, the repeater controller RCNT outputs the read data enable signal IRDEN having the active level to the flip-flop circuit FF7. The flip-flop circuit FF7 outputs the read data enable signal IRDEN to the memory group controller MCNT of the subsequent stage via the OR circuit OR.

The repeater controller RCNT outputs the read data enable signal IRDEN in the same clock cycle as the chip enable signal CEB for causing the memory group MG of the subsequent stage to perform the read operation. For this reason, the read data enable signal RDEN output from the flip-flop circuit FF7 is supplied to the memory group controller MCNT of the subsequent stage one clock cycle thereafter, after the read operation of the memory group MG of the subsequent stage starts. Hence, the memory group controller MCNT of the subsequent stage can hold the read data signal Q received from the corresponding memory group MG in the flip-flop circuit FF5.

In a case where the read operation is performed in the memory group MG of the preceding stage or the stage preceding the preceding stage, the repeater controller RCNT cancels the mask state of the mask circuit MSKR to the mask inactive state to output the read data signal Q to the memory group controller MCNT of the subsequent stage. During the read operation, the memory group controller MCNT of the last stage can perform a control to output the control signal CMD, the address signal A, the command address signal CAWD including the additional information, and the read data signal Q to the memory controller 200.

In addition, in a case where the write operation is performed in the memory group MG of the subsequent stage or the memory group MG of the stage subsequent to the subsequent stage, the repeater controller RCNT cancels the mask state of the mask circuit MSKW1 to the mask inactive state to transfer the write data signal D to the memory group controller MCNT of the subsequent stage. In addition, the repeater controller RCNT sets the mask circuit MSKW2 to the mask state to suppress the transfer of the write data signal D to the memory group MG of the memory group controller MCNT of the stage subsequento the memory group controller MCNT that includes the repeater controller RCNT described above.

The repeater controller RCNT cancels the mask state of the mask circuit MSKC to the mask inactive state to transfer the control signal CMD, the address signal A, and the command address signal CAWD including the additional information to the memory group controller MCNT of the subsequent stage. In addition, in a case where the write operation is performed in the memory group MG of the subsequent stage or the memory group MG subsequent to the subsequent stage, the repeater controller RCNT cancels the mask state of the mask circuit MSKC to the mask inactive state to transfer the control signal CMD, the address signal A, and the command address signal CAWD including the additional information to the memory group controller MCNT of the subsequent stage. In a case where the write operation is performed in the memory group controller MCNT's own memory group MG, the repeater controller RCNT sets the mask circuit MSKC to the mask state to suppress the transfer of the command address signal CAWD to the memory group controller MCNT of the subsequent stage.

In the case where the write operation is performed in the memory group controller MCNT's own memory group MG, the repeater controller RCNT sets the mask circuit MSKW1 to the mask state to suppress the transfer of the write data signal D to the memory group controller MCNT of the subsequent stage. Further, the repeater controller RCNT cancels the mask state of the mask circuit MSKW2 to the mask inactive state to transfer the write data signal D to the memory group MG of the memory group controller MCNT of the stage subsequento the memory group controller MCNT that includes the repeater controller RCNT described above.

In a case where the write operation is performed in the memory groups MG of the subsequent stage and the stages subsequent to the subsequent stage, the repeater controller RCNT cancels the mask state of the mask circuit MSKW1 to the mask inactive state to transfer the write data signal D to the memory group controller MCNT of the subsequent stage. In the case where the write operation is performed in the memory groups MG of the subsequent stage and the stages subsequent to the subsequent stage, the repeater controller RCNT sets the mask circuit MSKW2 to the mask state to suppress the transfer of the write data signal D to the memory group controller MCNT's own memory group MG.

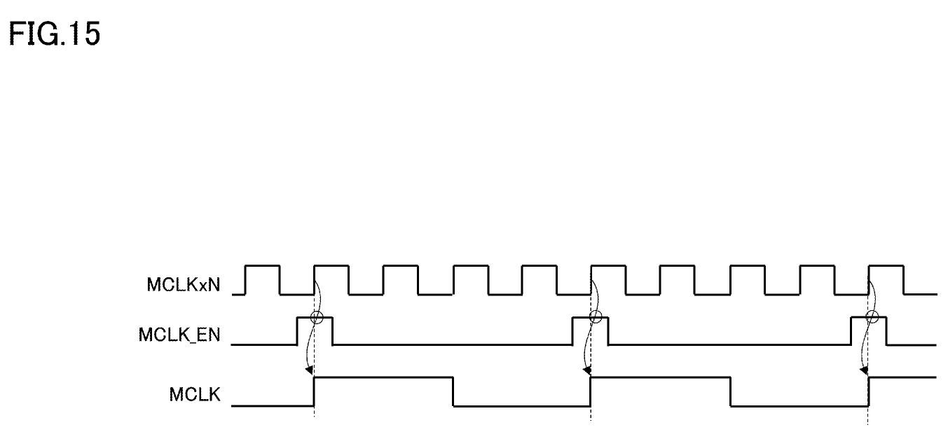

FIG. 15 illustrates an example of generating the memory clock signal MCLK from the memory clock signal MCLKxN. For example, each memory group controller MCNT may receive the memory clock signal MCLK and the clock enable signal MCLK_EN from the memory controller 200 and divide the frequency of the memory clock signal MCLKxN by four to generate the memory clock signal MCLK. In this case, each memory group controller MCNT generates the memory clock signal MCLK in synchronism with a rising edge of the memory clock signal MCLKxN that occurs during the high-level period of the clock enable signal MCLK_EN. A method of generating the memory clock signal MCLK is not limited to the method illustrated in FIG. 15.

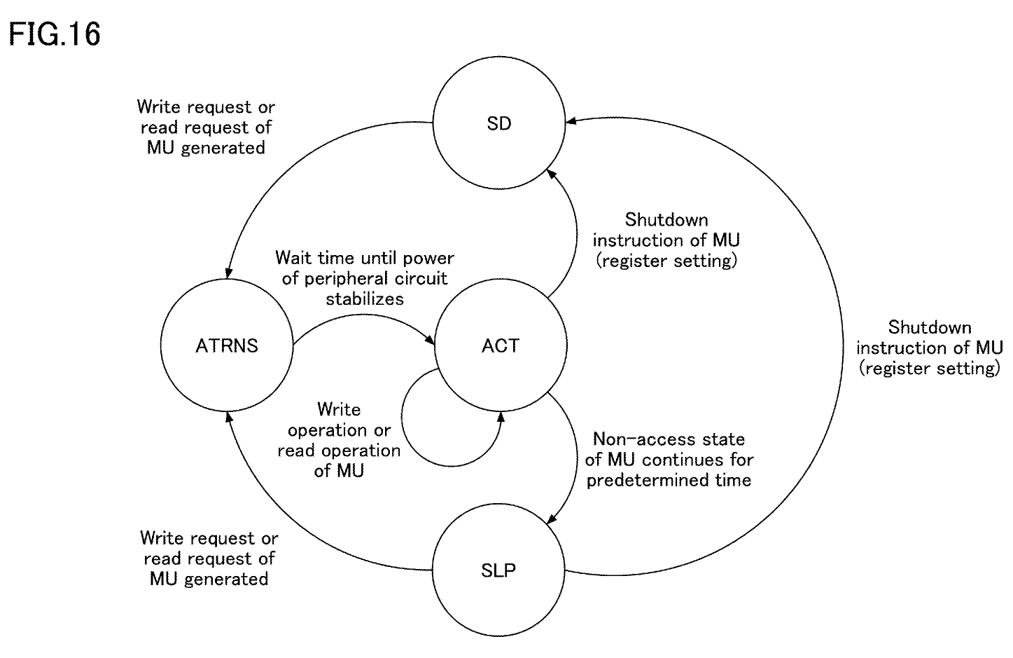

FIG. 16 is a state transition diagram illustrating an example of transitions of an operation state of the memory unit MU illustrated in FIG. 4. The state transitions illustrated in FIG. 16 are managed by the memory group controller MCNT that controls the operation of the memory unit MU. However, the transition to the shutdown mode SD is achieved by a register setting of the memory state manager 212 of the memory controller 200.

FIG. 16 illustrates the state transitions in units of switching among the shutdown mode SD, the sleep mode SLP, and the active mode ACT. For this reason, in a case where the switching among the shutdown mode SD, the sleep mode SLP, and the active mode ACT is performed in units of the memory groups MG, FIG. 16 illustrates the state transition of the memory group MG. In a case where the operation mode is switched in units of the memories MEM in the memory unit MU, FIG. 16 illustrates the state transition in units of the memories MEM. An example of a control in units of the memory units MU will be described below.

When activating the memory circuit 100 illustrated in FIG. 1, the states of all of the memory units MU are set to the shutdown mode SD. The memory unit MU in which the write request or the read request is generated makes a transition from the shutdown mode SD to an active transition mode ATRNS, and for example, the power of the peripheral circuits outside the memory cell area is turned on. Then, after a time it takes for the power to stabilize elapses, the memory unit MU makes a transition to the active mode ACT, and the write operation or the read operation is performed. In the active mode ACT, the write operation or the read operation is performed every time a write request or a read request of the memory unit MU is generated.

In the active mode ACT, in a case where a non-access state in which the write request or the read request is not generated continues for a predetermined time, the memory unit MU makes a transition to the sleep mode SLP. The sleep mode SLP is an example of a low power mode in which the power consumption is suppressed while holding the data in the memory unit MU. By switching the memory unit MU that does not perform the write operation or the read operation for the predetermined period from the active mode ACT to the sleep mode SLP, the power consumption of the memory circuit 100 can be reduced. In the sleep mode SLP, the memory unit MU in which the write request or the read request is generated makes a transition to the active transition mode ATRNS.

In a case where a shutdown instruction of the memory unit MU is generated in the active mode ACT or the sleep mode SLP, the memory unit MU makes a transition to the shutdown mode SD. The shutdown instruction is issued by register setting of the memory state manager 212 based on the reception of the control signal CNTL illustrated in FIG. 2, for example. Depending on the application, an embodiment may cause a transition of the memory unit MU to the shutdown mode SD in a case where the sleep mode SLP continues for the predetermined time. In this case, a duration of the sleep mode SLP may be set in advance in the register of the global manager 210 illustrated in FIG. 2.

In a case where frame image data held in the memory circuit 100 is always accessed within a certain period of time when processing a video image, for example, an automatic transition to the shutdown mode SD may be made if it can be guaranteed that the data held in the memory circuit 100 will not be utilized when there is no access to the data for a certain period of time or longer. For example, in a case where a memory access process is performed with a certain screen size and the screen size is switched to a smaller screen size in the middle of the memory access process, an unused memory area is generated in the memory area used such as when processing an original screen size in a case where the original screen size is switched to a smaller screen size. In such a case, by automatically causing a transition to the shutdown mode SD based on the duration of the sleep mode SLP, the access control of the memory circuit 100 can be facilitated compared to a case where the shutdown instruction is issued from the outside.

Statistical information, such as an access frequency or the like, may be acquired, and the duration of the sleep mode SLP until the transition to the shutdown mode SD may be set based on the acquired statistical information. In this case, the memory controller 200 additionally includes an acquisition circuit that acquires the statistical information, such as a time from the transition to the sleep mode until the transition to the active mode, the frequency of the transition from the active mode to the sleep mode, and the access frequency in the active mode, or the like. The memory controller 200 also additionally includes a circuit that calculates the duration of the sleep mode SLP until the transition to the shutdown mode SD.

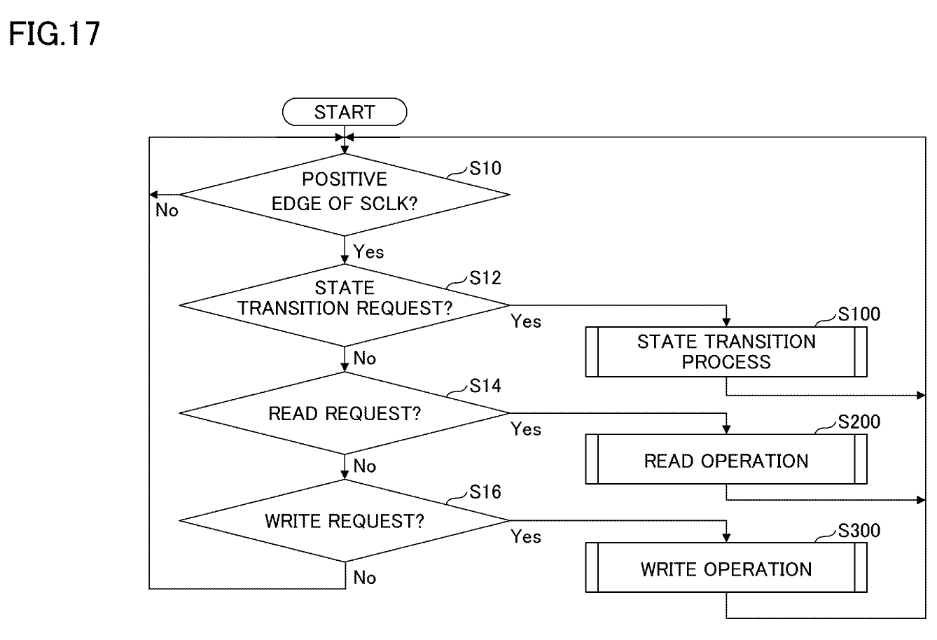

FIGS. 17 through 21 illustrate examples of the operation of the memory group controller MCNT illustrated in FIG. 14. The processes illustrated in FIGS. 17 through 21 are performed for every memory unit MU by the repeater controller RCNT of the plurality of memory group controllers MCNT in the memory circuit 100. FIGS. 17 through 21 illustrate the processes for an example in which the switching among the shutdown mode SD, the sleep mode SLP, and the active mode ACT is performed in units of the memory units MU.

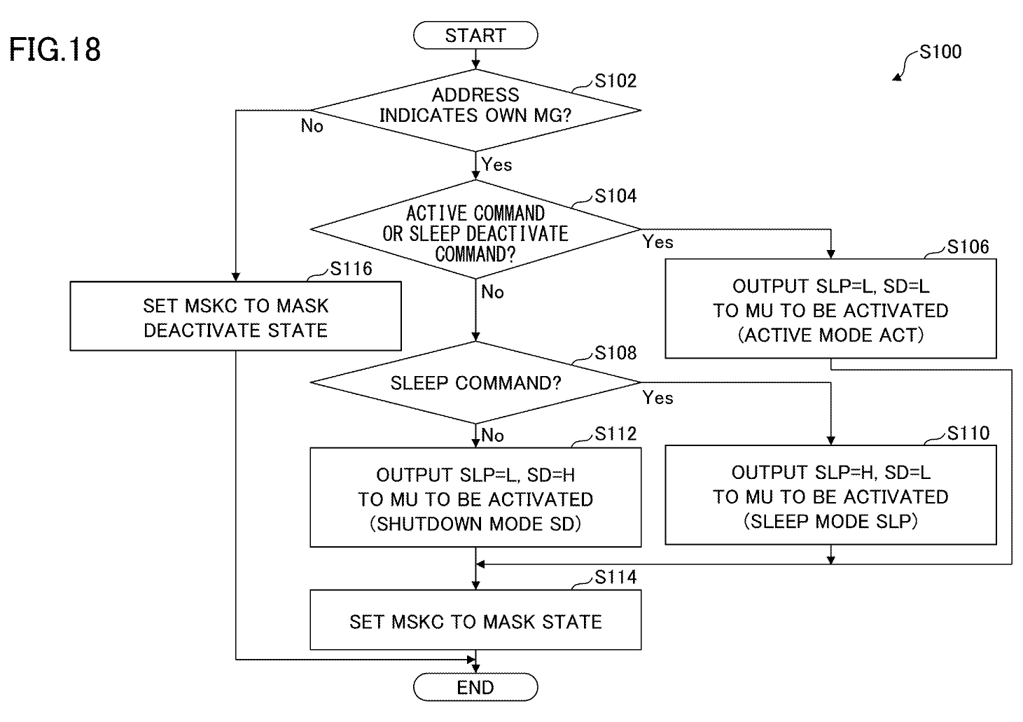

First, in step S10, the repeater controller RCNT waits until a positive edge of the system clock SCLK is detected, and performs the process of step S12 in a case where the positive edge is detected. In step S12, the repeater controller RCNT performs the process of step S100 (state transition process) in a case where a state transition request is issued, and performs the process of step S14 in a case where the state transition request is not issued. An example of the process of step S100 is illustrated in FIG. 18.

The state transition request is an active command for causing a transition to the active mode ACT, a sleep command for causing a transition to the sleep mode SLP, or a shutdown command for causing a transition to the shutdown mode SD. For example, in a case where the memory unit MU to be accessed is in the shutdown mode SD or the sleep mode SLP, the active command is issued by the corresponding repeater controller RCNT based on the issuance of the write request or the read request. The shutdown command is issued by the memory controller 200 based on a request issued to the memory circuit 100 via the system bus SBUS. The sleep command is issued by the corresponding repeater controller RCNT in a case wherethe memory unit MU in the active mode ACT is caused to make a transition to the sleep mode SLP. The sleep command may be issued by the memory controller 200 based on a request issued to the memory circuit 100 via the system bus SBUS.

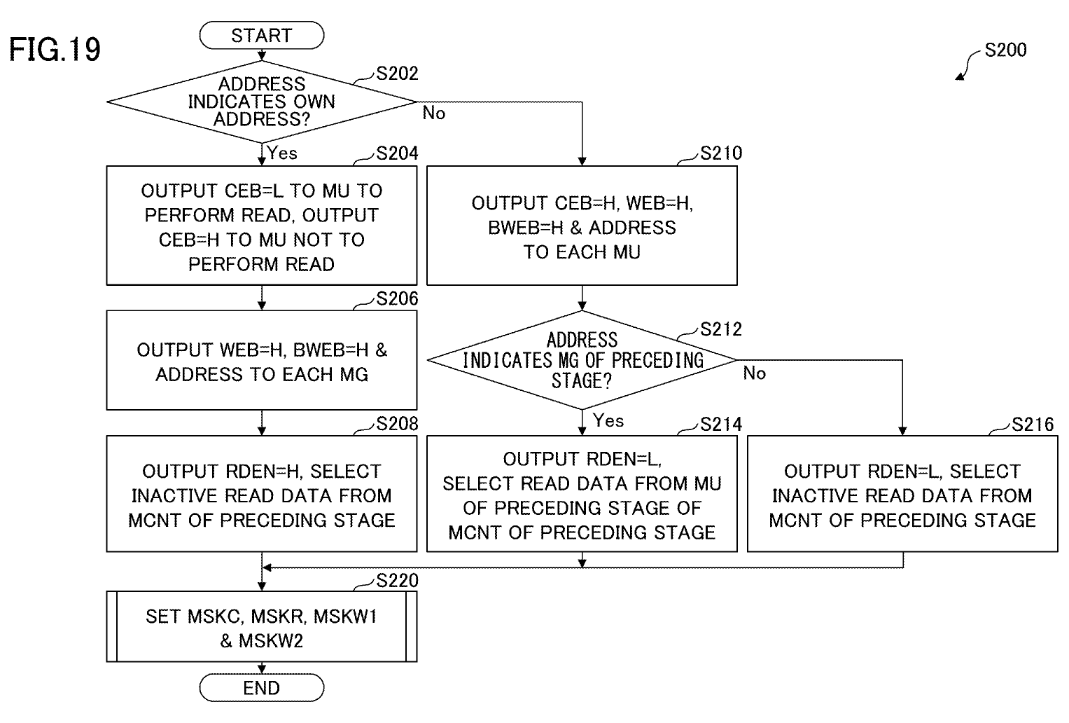

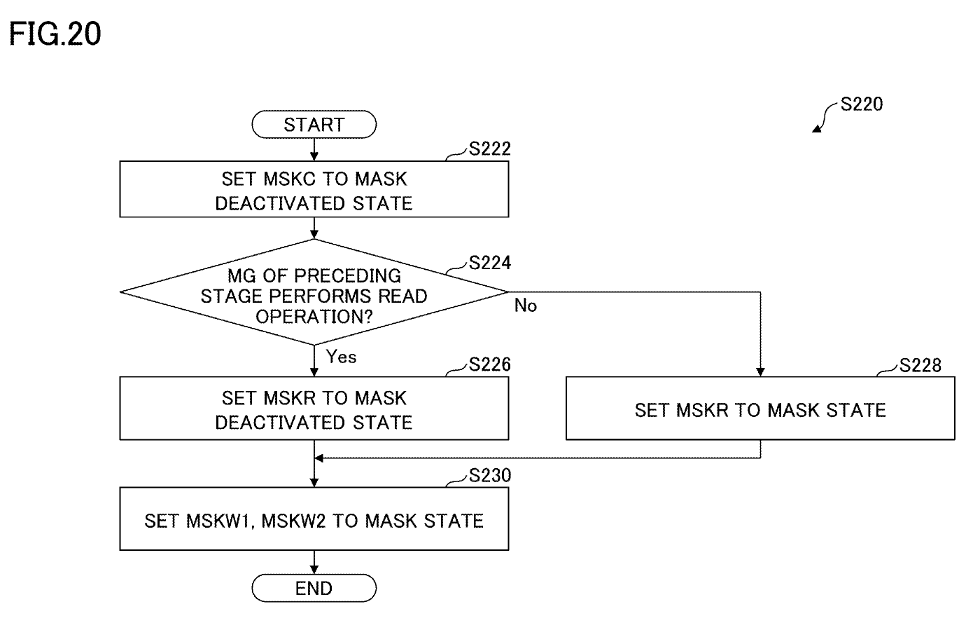

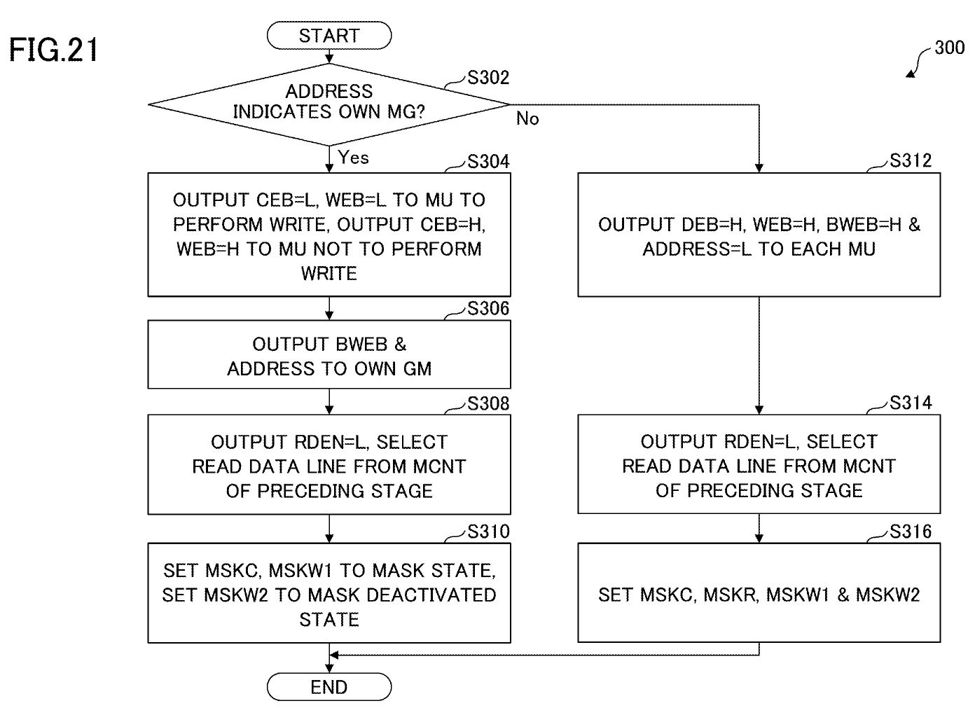

In step S14, the repeater controller RCNT performs the process of step S200 (read operation) in the case where the read request is issued, and performs the process of step S16 in the case where the read request is not issued. An example of the process of step S200 is illustrated in FIGS. 19 and 20. In step S16, the repeater controller RCNT performs the process of step S300 (write operation) in the case where the write request is issued, and the process returns to step S10 in the case where the write request is not issued. An example of the process of step S300 is illustrated in FIG. 21.

In step S100, the repeater controller RCNT performs the state transition process illustrated in FIG. 18, and the process returns to step S10. In step S200, the repeater controller RCNT performs the read process illustrated in FIGS. 19 and 20, and the process returns to step S10. In step S300, the repeater controller RCNT performs the write process illustrated in FIG. 21, and the process returns to step S10.

FIG. 18 illustrates an example of the step S100 (state transition process) illustrated in FIG. 17. First, in step S102, the repeater controller RCNT determines whether or not the address signal A received together with the state transition command indicates the memory group controller MCNT's own memory group MG. The memory group controller MCNT's own memory group MG refers to the memory group MG to be accessed by the memory group controller MCNT that performs the write operation or the read operation. The repeater controller RCNT performs the process of step S104 in a case where the address signal A indicates the memory group controller MCNT's own memory group MG, and performs the process of step S116 in a case where the address signal A does not indicate the memory group controller MCNT's own memory group MG.

In step S104, the repeater controller RCNT performs the process of step S106 in a case where the state transition command is the active command or the sleep deactivate command. In a case where the state transition command is not the active command or the sleep deactivate command, the repeater controller RCNT performs the process of step S108.

In step S106, the repeater controller RCNT outputs a low-level (L) sleep signal SLP and a low-level (L) shutdown signal SD to an active target memory unit MU indicated by the address signal A. As a result, the active target memory unit MU makes a transition to the active mode ACT. After the process of step S106, the process of step S114 is performed.

In step S108, the repeater controller RCNT performs the process of step S110 in a case where the state transition command is the sleep command, and performs the process of step S112 in a case where the state transition command is not the sleep command.

In step S110, the repeater controller RCNT outputs a high-level (H) sleep signal SLP and a low-level (L) shutdown signal SD to the active target memory unit MU (target to make a transition to the active mode ACT) indicated by the address signal A. Accordingly, the active target memory unit MU makes a transition to the sleep mode SLP. After the process of step S110, the process of step S114 is performed.

In step S112, the repeater controller RCNT outputs a low-level (L) sleep signal SLP and a high-level (H) shutdown signal SD to the active target memory unit MU indicated by the address signal A. As a result, the active target memory unit MU makes a transition to the shutdown mode SD. After the process of step S112, the process of step S114 is performed.

In step S114, the repeater controller RCNT sets the mask circuit MSKC to the mask state to suppress the transfer of the control signal CMD and the address signal A to the memory group controller MCNT of the subsequent stage, and the process illustrated in FIG. 18 ends. On the other hand, in step S116, the repeater controller RCNT sets the mask circuit MSKC to the mask inactive state to enable the transfer of the control signal CMD and the address signal A to the memory group controller MCNT of the subsequent stage, and the process illustrated in FIG. 18 ends.

FIG. 19 illustrates an example of the process of step S200 (read operation) illustrated in FIG. 17. First, in step S202, the repeater controller RCNT determines whether or not the address signal A received together with the read request signal indicating the read request indicates the memory group controller MCNT's own memory group MG. The repeater controller RCNT performs the process of step S204 in a case where the address signal A indicates the memory group controller MCNT's own memory group MG, and performs the process of step S210 in a case where the address signal A does not indicate the memory group controller MCNT's own memory group MG.

In step S204, the repeater controller RCNT outputs a low-level (L) chip enable signal CEB to the read target memory unit MU indicated by the address signal A. The repeater controller RCNT outputs a high-level (H) chip enable signal CEB to the memory unit MU that is not to perform the read operation.

Next, in step S206, the repeater controller RCNT outputs a high-level (H) write enable signal WEB and a high-level (H) bit write enable signal BWEB to the memory group controller MCNT's own memory group MG. The repeater controller RCNT outputs the address signal A received together with the control signal CMD to the memory group controller MCNT's own memory group MG.

Next, in step S208, the target repeater controller RCNT corresponding to the read target memory group MG outputs a high-level (H) read enable signal RDEN. The target repeater controller RCNT causes the selector SELQ to select the inactive read data signal Q from the memory group controller MCNT of the preceding stage. The repeater controller RCNT may cause the selector SELQ to select the inactive read data signal Q from the memory group MG of the preceding stage. After the process of step S208, the process of step S220 is performed.

In step S210, the repeater controller RCNT outputs a high-level (H) chip enable signal CEB, a high-level (H) write enable signal WEB, and a high-level (H) bit write enable signal BWEB to each memory unit MU. The repeater controller RCNT outputs a low-level (L) address signal A to each memory unit MU. By not causing a transition of the logic level of the address signal A, it is possible to reduce the power consumption during the read operation.

In step S212, the repeater controller RCNT determines whether or not the address signal A received together with the read request signal indicates the memory group MG on the preceding stage side (the preceding stage or the stage preceding the preceding stage). The repeater controller RCNT performs the process of step S214 in a case where the address signal A indicates the memory group MG on the preceding stage side, and performs the process of step S216 in a case where the address signal A does not indicate the memory group MG on the preceding stage side.

In step S214, the repeater controller RCNT outputs a low-level (L) read data enable signal RDEN. The repeater controller RCNT causes the selector SELQ to select the read data signal Q from the memory group MG of the preceding stage or the read data signal Q from the memory group controller MCNT of the preceding stage. Accordingly, the read data signal Q read from one of the memory units MU of the memory group MG on the preceding stage side can be transferred to the subsequent stage. The repeater controller RCNT receives a high-level (H) read data enable signal RDEN output from the memory group controller MCNT of the preceding stage by the OR circuit OR, and transfers the high-level (H) read data enable signal RDEN to the memory group controller MCNT of the subsequent stage. After the process of step S214, the process of step S220 is performed.

In step S216, the repeater controller RCNT outputs a low-level (L) read enable signal RDEN. The repeater controller RCNT causes the selector SELQ to select the inactive read data signal Q from the memory group controller MCNT of the preceding stage. The repeater controller RCNT may cause the selector SELQ to select the inactive read data signal Q from the memory group MG of the preceding stage. After the process of step S216, the process of step S220 is performed.

In step S220, the repeater controller RCNT sets the mask states of the mask circuits MSKC and MSKR, and the process illustrated in FIG. 12 ends.

FIG. 20 illustrates an example of the process of step S220 illustrated in FIG. 19. First, in step S222, the repeater controller RCNT sets the mask circuit MSKC to a mask inactive state, and enables the transfer of the control signal CMD and the address signal A to the memory group controller MCNT of the subsequent stage.

Next, in step S224, the repeater controller RCNT determines whether or not the memory group MG on the preceding stage side performs the read operation based on the address signal A received together with the read request signal. In a case where the memory group MG on the preceding stage side performs the read operation, the process of step S226 is performed. In a case where the memory group MG on the preceding stage side does not perform the read operation, the process of step S228 is performed.

In step S226, the repeater controller RCNT sets the mask circuit MSKR to a mask inactive state, and enables transfer of the read data signal Q from the memory group MG of the preceding stage or the read data signal Q from the memory group controller MCNT of the preceding stage to the subsequent stage. After the process of step S226, the process of step S230 is performed.

In step S228, the repeater controller RCNT sets the mask circuit MSKR to the mask state because the read data signal Q from the memory group MG of the preceding stage or the read data signal Q from the memory group controller MCNT of the preceding stage is not transferred. By suppressing the transfer of the inactive read data signal Q, the power consumption during the read operation can be reduced. After the process of step S228, the process of step S230 is performed.

In step S230, the repeater controller RCNT sets the mask circuits MSKW1 and MSKW2 to the mask state, and the process illustrated in FIG. 20 ends. By suppressing the inactive write data signal D and the transfer of the inactive write data signal D, the power consumption can be reduced.

FIG. 21 illustrates an example of the process of step S300 (write operation) illustrated in FIG. 17. First, in step S302, the repeater controller RCNT determines whether or not the address signal A received together with the write request signal indicates the memory group controller MCNT's own memory group MG. The repeater controller RCNT performs the process of step S304 in a case where the address signal A indicates the memory group controller MCNT's own memory group MG, and performs the process of step S312 in a case where the address signal A does not indicate the memory group controller MCNT's own memory group MG.

In step S304, the repeater controller RCNT outputs a low-level (L) chip enable signal CEB and a low-level (L) write enable signal WEB to the memory unit MU which is a write target indicated by the address signal A. The repeater controller RCNT outputs a high-level (H) chip enable signal CEB and a high-level (H) write enable signal WEB to the memory unit MU that is not the write target.

Next, in step S306, the repeater controller RCNT outputs the bit write enable signal BWEB included in the control signal CMD and the address signal A received together with the control signal CMD to the memory group controller MCNT's own memory group MG.

Next, in step S308, the repeater controller RCNT outputs a low-level (L) read enable signal RDEN. The repeater controller RCNT causes the selector SELQ to select the inactive read data signal Q from the memory group controller MCNT of the preceding stage. The repeater controller RCNT may cause the selector SELQ to select the inactive read data signal Q from the memory group MG of the preceding stage.

Next, in step S310, the repeater controller RCNT sets the mask circuits MSKC and MSKW1 to the mask state, sets the mask circuit MSKW2 to the mask inactive state, and the operation illustrated in FIG. 21 ends. By setting the mask circuit MSKC to the mask state, the transfer of the control signal CMD and the address signal A to the subsequent stage side unrelated to the write operation is suppressed, and thus, the power consumption during the write operation can be reduced. By setting the mask circuit MSKW1 to the mask state, the transfer of the write data signal D to the subsequent stage is suppressed, and thus, the power consumption during the write operation can be reduced. By setting the mask circuit MSK2 to the mask inactive state, the write data signal D can be transferred to the write target memory unit MU.

In step S312, the repeater controller RCNT outputs a high-level (H) chip enable signal CEB, a high-level (H) write enable signal WEB, and a high-level (H) bit write enable signal BWEB to each memory unit MU. The repeater controller RCNT outputs a low-level (L) address signal A to each memory unit MU. Accordingly, similar to the process of step S210 illustrated in FIG. 19, the power consumption during the write operation can be reduced.

Next, in step S314, the repeater controller RCNT outputs a low-level (L) read enable signal RDEN. The repeater controller RCNT causes the selector SELQ to select the inactive read data signal Q from the memory group controller MCNT of the preceding stage. The repeater controller RCNT may cause the selector SELQ to select the inactive read data signal Q from the memory group MG of the preceding stage.

Next, in step S316, the repeater controller RCNT sets the mask state or the mask inactive state of the mask circuits MSKC, MSKR, MSKW1, and MSKW2. First, the repeater controller RCNT sets the mask circuit MSCR to the mask state. Next, the repeater controller RCNT determines whether or not the memory group MG on the preceding stage side performs the write operation, based on the address signal A received together with the write request signal.

In a case where the memory group MG on the preceding stage side performs the write operation, the repeater controller RCNT sets the mask circuits MSKC, MSKW1, and MSKW2 to the mask state. In a case where the memory group MG on the preceding stage side does not perform the write operation, the repeater controller RCNT sets the mask circuits MSKC and MSKW1 to the mask inactive state and sets the mask circuit MSKW2 to the mask state. Then, after the repeater controller RCNT performs the process of step S316, the process illustrated in FIG. 21 ends. In a case where the access request signal and the write data signal D are not transferred to the subsequent stage side, the mask circuits MSKC and MSKW1 are set to the mask state, to make it possible to reduce the power consumption during the write operation.

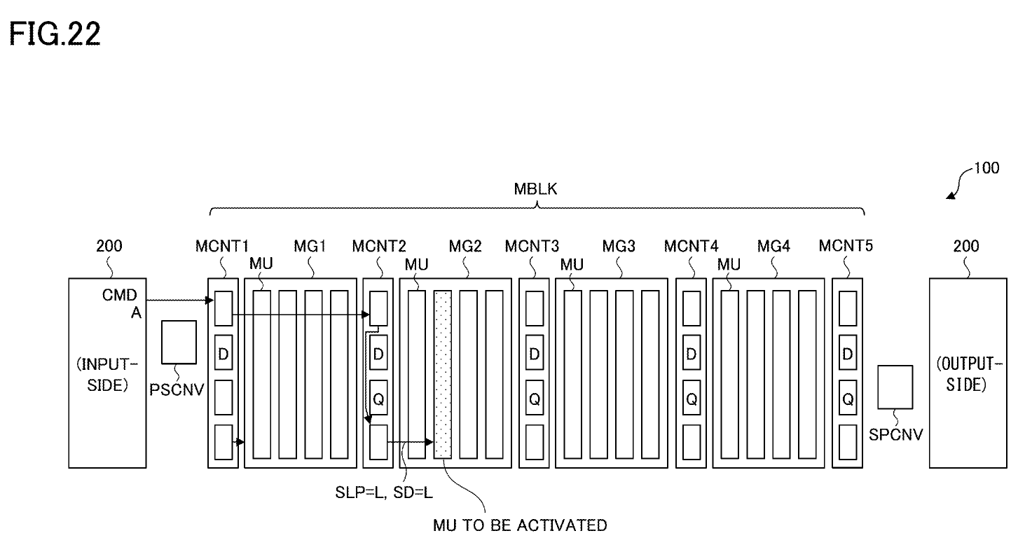

FIG. 22 illustrates an example of an operation for causing a transition of the memory unit MU to the active mode ACT in the memory circuit 100 illustrated in FIG. 1. In FIG. 22, the operation for causing a transition of the memory unit MU indicated by dot-patterns in the memory group MG2 to the active mode will be described. The memory unit MU indicated by the dot-patterns in the memory group MG2 will also be referred to as a target memory unit MU (illustrated as an active target MU in FIG. 22). In FIG. 22, only the signals used for the transition to the active mode ACT are illustrated.

In a case where the memory controller 200 receives an access request signal (a write request signal or a read request signal) during the shutdown mode SD, the memory controller 200 outputs a state transition request for causing the memory unit MU to be accessed to make a transition from the shutdown mode SD to the active mode ACT. In addition, in a case where the memory controller 200 receives the access request signal during the sleep mode SLP, the memory controller 120 outputs a state transition request for causing the memory unit MU to be accessed to make a transition from the sleep mode SLP to the active mode ACT.

According to the instruction from the memory controller 200, each memory group controller MCNT outputs a low-level (L) shutdown signal SD and a low-level (L) sleep signal SLP to the corresponding memory unit MU when the instruction is a memory state transition request with respect to memory unit MU in the memory group controller MCNT's own memory group MG.

The memory control circuit 200 outputs a state transition request for setting the target memory unit MU to the active mode to the memory group controller MCNT1 of the first stage. The memory group controller MCNT1 determines that the memory unit MU included in the memory group controller MCNT1's own memory group MG1 is not the target memory unit MU, based on the address signal A included in the state transition request. For this reason, the memory group controller MCNT1 transfers the state transition request to the memory group controller MCNT2 of the subsequent stage.

The memory group controller MCNT2 determines that the memory unit MU included in the memory group controller MCNT2's own memory group MG2 is the target memory unit MU, based on the address signal A included in the state transition request. Further, the memory group controller MCNT2 outputs a low-level (L) sleep signal SLP and a low-level (L) shutdown signal SD to the target memory unit MU of the memory group MG2. Because the memory group controller MCNT2 determines that the memory units MU in the memory group controller MCNT2's own memory group MG2 include the target memory unit MU, the state transition request is not transferred to the memory group controllers MCNT3 and MCNT4 of the subsequent stages.

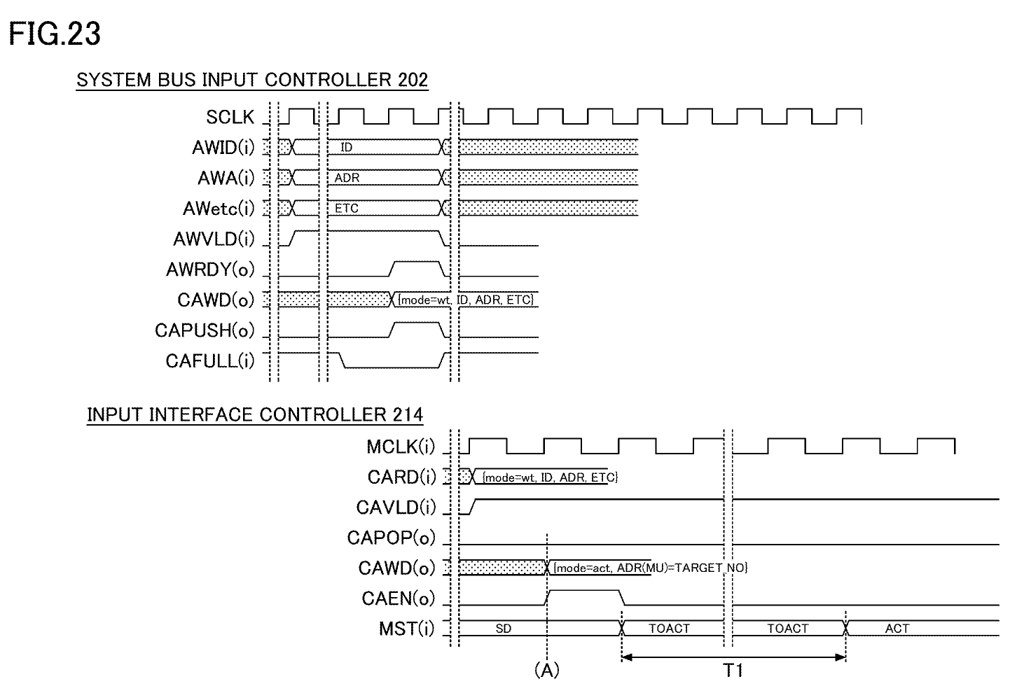

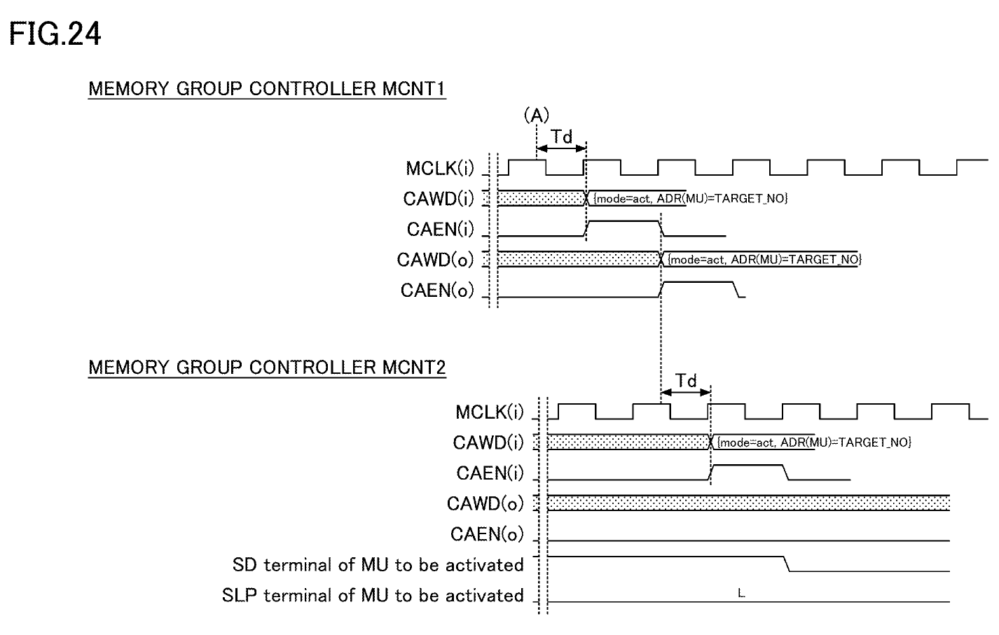

FIGS. 23 and 24 illustrate an example of timings of signals when making the transition to the active mode ACT illustrated in FIG. 22. FIGS. 23 and 24 illustrate timing waveforms of various signals corresponding to the operation described with reference to FIG. 22. In FIGS. 23 and 24 and timing charts which will be described later, a label (i) added to the end of the signal name indicates that the signal is an input signal to a target circuit, and a label (o) added to the end of the signal name indicates that the signal is an output signal from the target circuit. In the following description, each signal may be described by the label assigned thereto instead of the signal name. The signal names illustrated in the waveforms of the timing charts illustrated in FIG. 23 and the subsequent figures may be different from the signal names described above. For example, a label ID indicates a command signal or the like indicating various commands, a label ADR indicates an address signal A, and a label ETC indicates other control signals or the like. Labels AWID(i), AWetc(i), and AWVLD(i) indicate request signals REQ from the system bus SBUS. A label AWA(i) indicates an address signal ADR from the system bus SBUS. A label AWRDY(o) indicates an acknowledge signal to the system bus SBUS.

The system bus input controller 202 illustrated in FIG. 2 detects that active AWID signal, AWA signal, and AWetc signal, which are examples of the request signal REQ and the address signal ADR, are supplied from the system bus SBUS, based on a high-level (H) AWVLD signal (an example of the request signal REQ and the address signal ADR) input from the system bus SBUS. The AWID signal includes information identifying the state transition request, and the AWA signal indicates the address to be used in the state transition request. The AWetc signal indicates additional information used in the state transition request.

The system bus input controller 202 stores (pushes), in the buffer 204, the control signal CMD including the additional information and the CAWD signal including the 512-bit address A, which is the access unit of the memory area, converted from the AWID signal, the AWA signal, and the AWetc signal received during the high-level period of the AWVLD signal. After confirming that there is a free space in the buffer 204 based on a low-level (L) CAFULL signal, the system bus input controller 202 outputs a high-level (H) AWRDY signal (acknowledge signal) indicating that the state transition request is received to the system bus SBUS. The CAFULL signal is set to a high level when there is no free space in the buffer 204. The CAPUSH signal indicates a storage timing of the buffer 204.

The input interface controller 214 confirms the information held in the buffer 204, and detects the target memory unit MU to make the state transition, based on the address information. The input interface controller 214 receives the state of the target memory unit MU to make the state transition from the memory state manager 212, as a MST signal.

For example, it is assumed that the MST signal is in the shutdown mode SD or the sleep mode SLP. In this case, the input interface control circuit 214 outputs a switch instruction to switch to the active mode and information indicating the active target memory unit MU to the memory group control circuit MCNT1 of the first stage. The switch instruction to switch to the active mode and the information indicating the active target memory unit MU are output to the memory group controller MCNT1 as the CAWD signal in synchronism with a high level of the CAEN signal.

The switch instruction to switch to the active mode is also output to the memory state manager 212. The memory state manager 212 switches the MST signal from the shutdown mode SD to a transition mode TOACT to the active mode ACT during a next clock cycle after receiving the switch instruction to switch to the active mode. Further, the memory state manager 212 sets the MST signal to the active mode ACT after a time T1 elapses.

In FIG. 24, a label (A) indicates a timing of the label (A) illustrated in FIG. 23. There is a physical distance from the output of the input interface controller 214 to the input of the memory group controller MCNT1. For this reason, the signal output from the input interface controller 214 reaches the memory group controller MCNT1 after a time Td. In this example, the target memory unit MU to make the state transition is included in the memory group MG of the stage subsequent to the memory group controller MCNT2, and is controlled by the memory group controller MCNT2. For this reason, the memory group controller MCNT1 transfers the CAWD signal to the memory group controller MCNT2 one clock cycle after receiving the CAWD signal indicating the switch instruction to switch to the active mode.

The memory group controller MCNT2 detects that the memory unit MU in the memory group controller MCNT2's own memory group MG is an active target, based on the address included in the received CAWD signal. Further, the memory group controller MCNT2 sets the shutdown terminal SD of the active target memory unit MU from the high level to the low level, and causes the active target memory unit MU make a transition to the active mode. Because the active target memory unit MU is detected, the memory group controller MCNT2 masks the output of the CAWD(o) and CAEN(o) signals to the memory group controller MCNT3 of the subsequent stage and does not transfer the CAWD(o) and CAEN(o) signals.

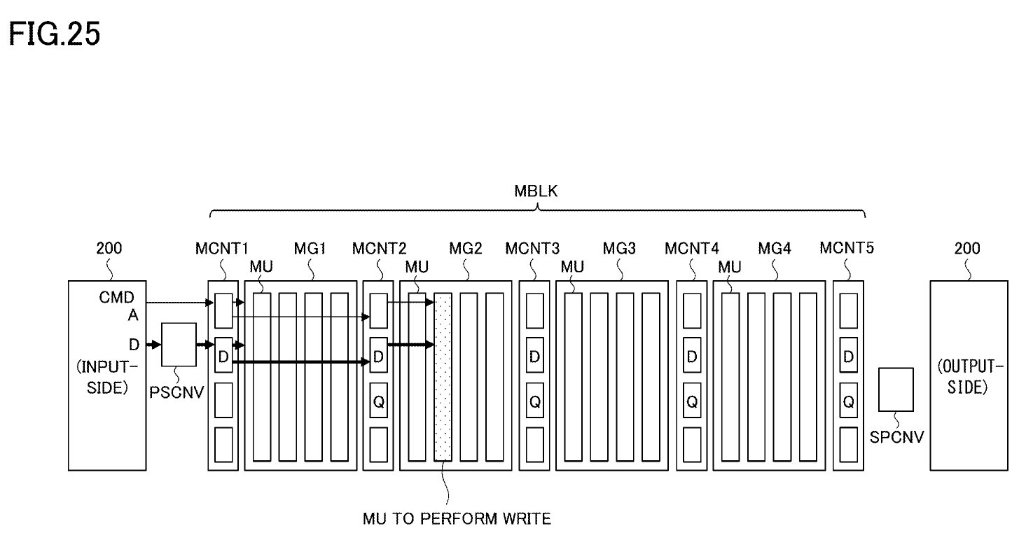

FIG. 25 illustrates an example of the write operation of the memory circuit 100 illustrated in FIG. 1. A detailed description of the operation that is the same as that illustrated in FIG. 22 will be omitted. In FIG. 25, the operation when writing data to a write target memory unit MU to perform the write operation indicated by dot-patterns in the memory group MG2 will be described.

In a case where the memory controller 200 receives the write request signal, as described with reference to FIG. 2, the memory controller 120 sequentially stores 512 bits obtained by collecting up to eight write data signals WD (for example, 64 bits) received via the system bus SBUS and one bit of a LAST signal (hereinafter, a description of the LAST signal will be omitted unless indicated otherwise) which will be described later, in the buffer 206 illustrated in FIG. 2. In a case where the memory unit MU including the write target memory cell MC is in the shutdown mode, the memory controller 200 causes the memory unit MU to make a transition to the active mode as illustrated in FIG. 22, and then performs the operation illustrated in FIG. 25.

The memory controller 200 outputs a 512-bit write data signal D to the data converter PSCNV, and converts the 512-bit write data signal D into four 128-bit serial write data signals D, for example. The four serial write data signals D are supplied to the memory group controller MCNT1 of the first stage together with the control signal CMD and the address signal A. The memory group controller MCNT1 determines that the memory group controller MCNT1's own memory group MG1 is not a write target, based on the received address signal A. For this reason, the memory group controller MCNT1 transfers the control signal CMD, the address signal A, and the write data signals D to the memory group controller MCNT2 of the subsequent stage.

The memory group controller MCNT2 determines that the memory group MG2 is a write target based on the received address signal A. Further, the memory group controller MCNT2 outputs the control signal CMD and the address signal A to the write target memory unit MU. In addition, the memory group controller MCNT2 sequentially outputs the four 128-bit write data signals D to the write target memory unit MU. Hence, the data is written to the write target memory cell MC.

As illustrated in FIG. 25, because the address signal received together with the write request signal indicates the memory group controller MCNT2's own memory group MG, the memory group controller MCNT2 masks the transfer of the control signal CMD, the address signal A, and the write data signal D to the memory group controller MCNT3 of the subsequent stage. In a case where the address signal received together with the write request signal indicates a memory group MG other than the memory group controller MCNT's own memory group MG, the memory group controller MCNT transfers the write request signal and the address signal to the memory group controller MCNT of the subsequent stage.

Accordingly, compared to a case where the control signal CMD, the address signal A, and the write data signal D are supplied in common to each memory group MG, for example, the charge and discharge currents of the control line CMD, the address line A, and the write data line D can be suppressed. As a result, it is possible to suppress an increase in dynamic power while suppressing an increase in the access time of the memory circuit 100.

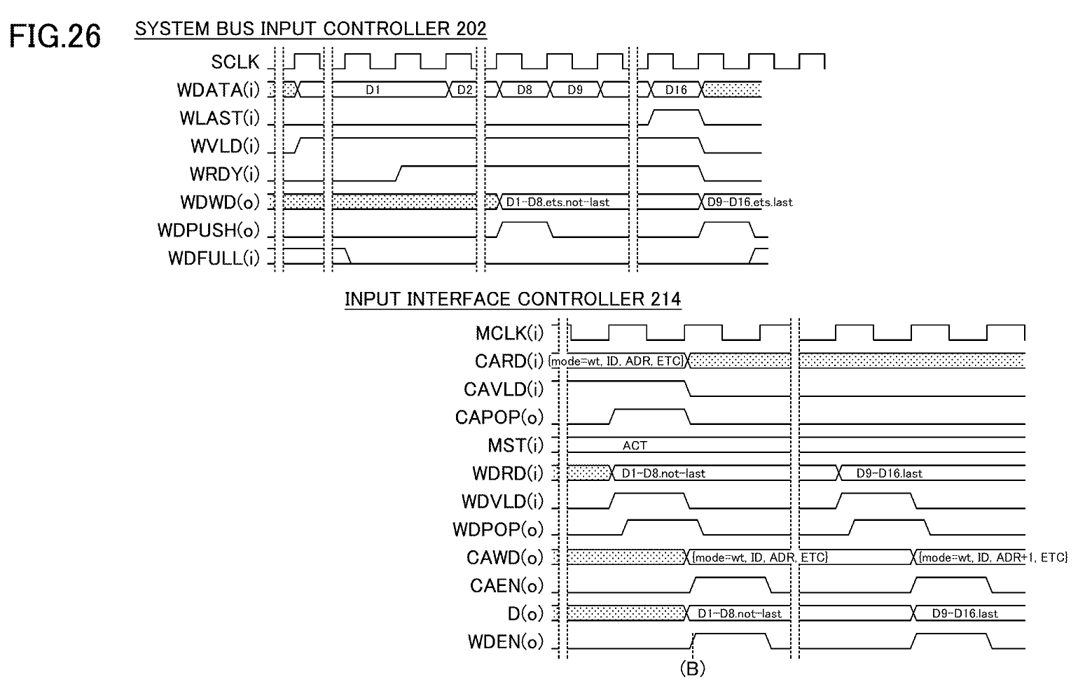

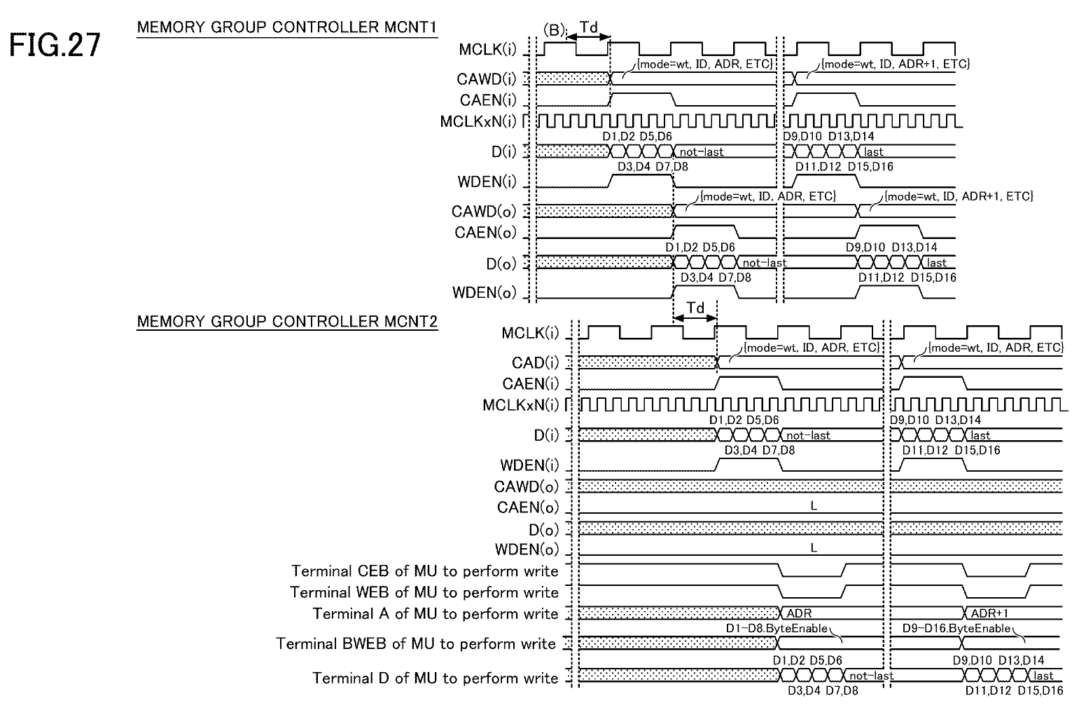

FIGS. 26 and 27 illustrate an example of the timings of signals during the write operation illustrated in FIG. 25. A detailed description of the operation that is the same as that illustrated in FIGS. 23 and 24 will be omitted. FIGS. 26 and 27 illustrate timing waveforms of various signals corresponding to the write operation described with reference to FIG. 25.

The system bus input controller 202 illustrated in FIG. 2 detects that an active WDATA signal (data) or the like is supplied, based on a high-level (H) WVLD signal. The WDATA signal includes data to be written to the memory cell MC by the write operation, a write address, or the like.

The system bus input controller 202 temporarily stores the DWATA signal received during the high-level period of the WVLD signal, and stores (pushes) the data signals in the buffers 204 and 206 by combining a maximum of eight data signals into 512 bits. The system bus input controller 202 confirms that there is free space in the buffers 204 and 206 based on a low-level (L) WFULL signal, and thereafter outputs a high-level (H) WRDY signal (acknowledge signal) indicating that the write request is received to the system bus SBUS.

The WPUSH signal indicates a storage timing of the write data signal or the like in the buffers 204 and 206. In this embodiment, every time a 64-bit data signal is received from the system bus SBUS eight times, a 512-bit data signal is collectively stored in the buffer 206. In this case, a WLAST signal indicating that the data signal from the system bus SBUS is the last data is stored in the buffer 204. In FIGS. 26 and 27, "not-last" in the write data signal D indicates that the data is not the last data, and "last" in the write data signal D indicates that the data is the last data.

In a case where the write request is detected from the information held in the buffer 204, the input interface controller 214 reads the control signal CMD, the address signal A, and the write data signal D from the buffers 204 and 206. The input interface controller 214 determines whether or not the write data signal D is the last write data signal D, based on the "last" and "not-last" in WDRD illustrated in FIG. 26. This example illustrates that the 512-bit write data signal D is acquired two times from the buffer 206.

The input interface controller 214 generates a CAWD signal, a CAEN signal, a write data signal D, and a WDEN signal, based on the control signal CMD, the address signal A, and the write data signal D read from the buffers 204 and 206. The input interface controller 214 outputs the CAWD signal, the CAEN signal, and the WDEN signal to the memory group controller MCNT1 of the first stage, and outputs the write data signal D to the data converter PSCNV.

In FIG. 27, a label (B) indicates a timing of the label (B) illustrated in FIG. 26. The memory group controller MCNT1 receives the signal output from the input interface controller 214 after the time Td. The memory group controller MCNT1 determines that the memory group controller MCNT1's own memory group MG is not a write access target, based on the received control signal CMD and address signal A. For this reason, the memory group controller MCNT1 transfers the signal received from the input interface controller 214 to the memory group controller MCNT2 of the subsequent stage.

The memory group controller MCNT1 receives four write data signals D output 128 bits at a time from the input interface controller 214, in synchronism with the memory clock signal MCLKxN. The memory group controller MCNT1 transfers the received four write data signals D to the memory group controller MCNT2 in synchronism with the memory clock signal MCLKxN. Labels D1 through D8 illustrated in the write data signal D indicate eight write data signals WD sequentially received by the system bus input controller 202 illustrated in FIG. 2. That is, each of the four 128-bit write data signals D includes data of two write data signals WD.

The memory group controller MCNT2 detects that the memory unit MU in the memory group controller MCNT2's own memory group MG is a write target, based on the received control signal CMD and address signal A. Further, the memory group controller MCNT2 sets the CEB terminal and the WEB terminal of the write target memory unit MU to a low level. The memory group controller MCNT2 sequentially receives four write data signals D in synchronism with the memory clock signal MCLKxN.

The memory group controller MCNT2 outputs an address A and a bit write enable signal BWEB to the A terminal and the BWEB terminal of the write target memory unit MU, and sequentially outputs four write data signals D to the D terminal of the write target memory unit MU in synchronism with the memory clock signal MCLKxN. As a result, data is written to the memory cell MC of the write target memory unit MU. Because the address signal A received together with the write request signal indicates the memory group controller MCNT2's own memory group MG, the memory group controller MCNT2 masks the transfer of the signals CAWD(o), CAEN(o), D(o), and WDEN(o) to the memory group controller MCNT3 of the subsequent stage.

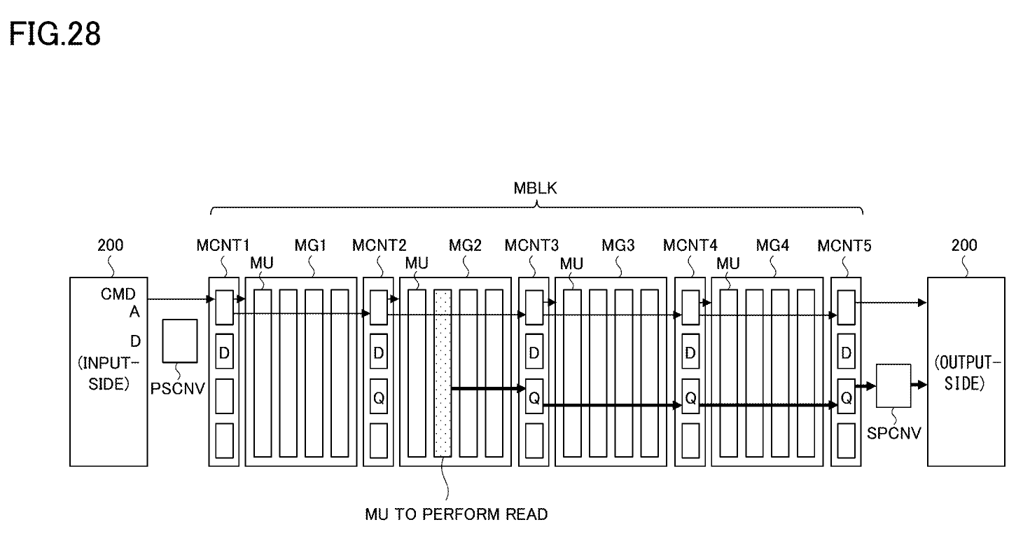

FIG. 28 illustrates an example of the read operation of the memory circuit 100 illustrated in FIG. 1. A detailed description of the operation that is the same as that illustrated in FIGS. 22 and 25 will be omitted. In FIG. 28, the operation when reading data from a read target memory unit MU to perform the read operation indicated by dot-patterns in the memory group MG2 will be described.

In a case where the memory controller 200 receives the read request, the memory controller 120 operates in the same manner as when the memory controller 120 receives the write request, except that the memory controller 120 does not receive the write data signal D. In a case where the memory unit MU including the read target memory cell MC is in the shutdown mode, the memory controller 200 performs the operation illustrated in FIG. 28 after causing the target memory unit MU (illustrated as an active target MU in FIG. 28) to make a transition to the active mode as illustrated in FIG. 22.

The output-side memory controller 200 outputs the control signal CMD and the address signal A to the memory group controller MCNT1 of the first stage. The memory group controller MCNT1 determines that the memory group controller MCNT1's own memory group MG1 is not a read target, based on the received address signal A. For this reason, the memory group controller MCNT1 transfers the control signal CMD and the address signal A to the memory group controller MCNT2 of the subsequent stage.

The memory group controller MCNT2 determines that the memory group controller MCNT2's own memory group MG2 is a read target, based on the received address signal A. The memory group controller MCNT2 outputs a control signal CMD and an address signal A to each read target memory unit MU. Further, the read data signal Q is read from the read target memory cell MC, and is output to the memory group controller MCNT3 of the subsequent stage.

The memory group controller MCNT3 transfers the received control signal CMD, address signal A, and read data signal Q to the memory group controller MCNT4 of the subsequent stage. The memory group controller MCNT4 transfers the received control signal CMD, address signal A, and read data signal Q to the memory group controller MCNT5 of the subsequent stage. The memory group controller MCNT5 outputs the received read data signal Q to the output-side memory controller 200 via the data converter SPCNV, based on the received control signal CMD and address signal A.

The data converter SPCNV converts the four sequentially received 128-bit read data signals Q into a 512-bit read data signal Q, and outputs the 512-bit read data signal Q to the memory controller 200. The memory controller 200 outputs the received 512-bit read data signal Q multiple times as serial read data signals DT (of 64 bits, for example).

The read data lines to which the read data signals Q are transferred are wired for every memory group MG, and are sequentially electrically connected via the memory group controller MCNT. For this reason, when the memory group MG2 performs the read operation, the read data signal Q is not transmitted to the read data line of the memory group MG1 located on the preceding stage side of the memory group MG2. Accordingly, the dynamic power of the memory block MBLK during the read operation can be reduced when compared to a case where the read data line is wired in common to all of the memory groups MG.

During the read operation, the memory block MBLK can receive the access request signal from the input-side memory controller 200, and output the read data signal Q to the output-side memory controller 200. Accordingly, a sum of a length of the signal line for transferring the access request signal from the memory controller 200 to the read target memory group MG and a length of the signal line for transferring the read data signal Q to the memory controller 200 can be made approximately constant regardless of the access position. As a result, it is possible to suppress the read access time from varying depending on the position of the memory group MG that performs the read operation.

In a case where the address signal A included in the read request signal indicates the memory group controller MCNT's own memory group MG, the memory group controller MCNT outputs the read request signal to the memory group controller MCNT's own memory group MG. In a case where the address signal included in the read request signal indicates a memory group MG other than the memory group controller MCNT's own memory group MG, the memory group controller MCNT transfers the read request signal to the memory group controller MCNT of the subsequent stage.

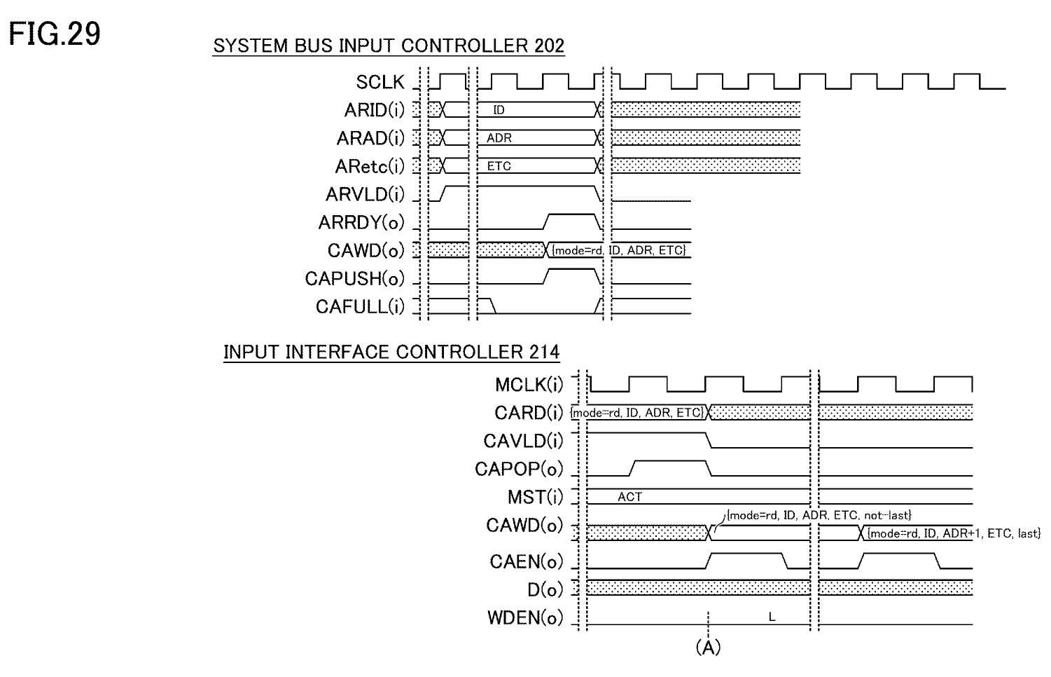

FIGS. 29 through 32 illustrate an example of the timings of signals during the read operation illustrated in FIG. 28. A detailed description of the operation that is the same as that illustrated in FIGS. 23, 24, 26, and 27 will be omitted. FIGS. 29 through 32 illustrate timing waveforms of various signals corresponding to the read operation described with reference to FIG. 28. Labels ARID(i), ARetc(i), and ARVLD(i) indicate request signals REQ from the system bus SBUS. A label ARAD(i) indicates an address signal ADR from the system bus SBUS. A label ARRDY(o) indicates an acknowledge signal to the system bus SBUS.

In FIG. 29, the system bus input controller 202 illustrated in FIG. 2 stores (pushes), in the buffer 204, a CAWD signal that includes a control signal CMD including additional information and an address A indicating a storage location of 512 bits (four 128-bit data) which is an access unit of the memory area, converted from an ARID signal (command), an ARAD signal (address), and a ARetc signal (other signals), which are examples of the request signal REQ and the address signal ADR received from the system bus SBUS during a high-level period of the ARVLD signal (an example of the request signal REQ and the address signal ADR) input from the system bus SBUS. The system bus input controller 202 confirms that there is free space in the buffer 204 based on a low-level (L) CAFULL signal input from the system bus SBUS, and thereafter outputs a high-level (H) ARRDY signal (acknowledge signal) indicating that the read request is received to the system bus SBUS. The CAPUSH signal indicates the storage timing of a read request signal or the like included in the read request in the buffer 204.

In a case where a read request is detected from the information held in the buffer 204, the input interface controller 214 reads the control signal CMD, the address signal A, or the like from the buffer 204. The input interface controller 214 outputs information used for the read access to the memory group controller MCNT1 of the first stage, based on the control signal CMD, the address signal A, or the like read from the buffer 204. For example, the signals output for use in the read access are the CAWD signal, the CAEN signal, and the WDEN signal. During the read operation, the write data line D is not used.

In a case where a burst length, which is the number of times the read data signal RD is output with respect to one read request, is large, the read request may not be completed by one access to the memory unit MU. In this case, the input interface controller 214 generates a second and subsequent read requests. The "not-last" in the COWD indicates that the read request is not the last, and the "last" indicates that the read request is the last. It is assumed that four 128-bit read data signals Q are read in one burst operation.

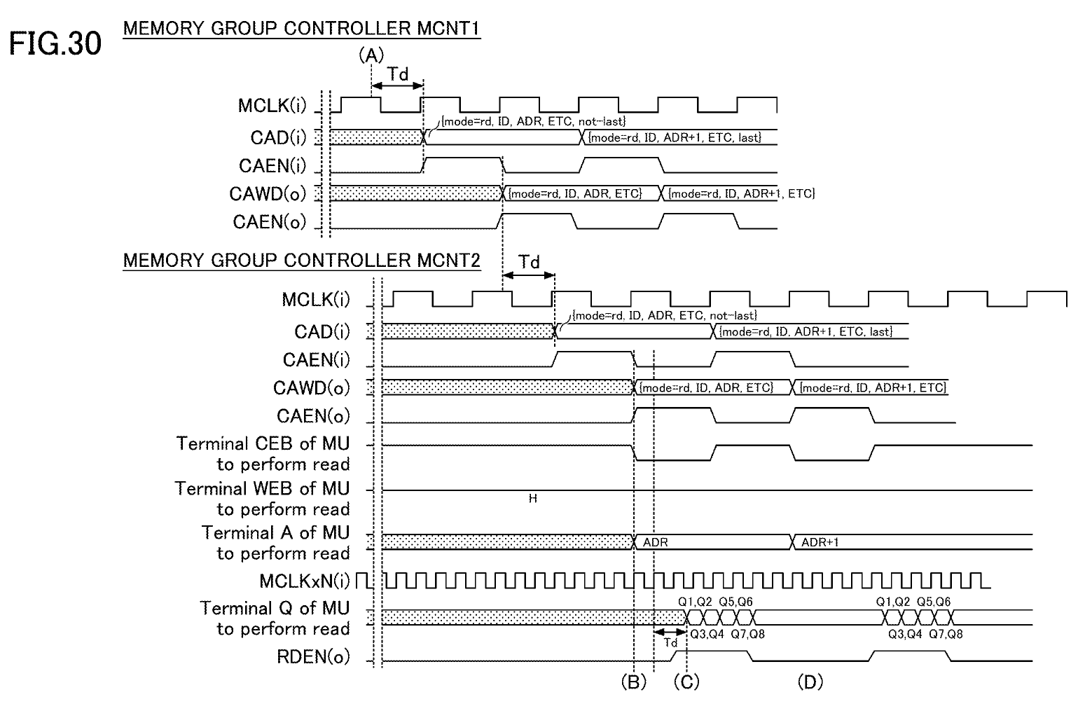

In FIG. 30, a label (A) indicates a timing of the label (A) illustrated in FIG. 29. The memory group controller MCNT1 receives the signal output from the input interface controller 214 after the time Td. The memory group controller MCNT1 determines that the memory group controller MCNT1's own memory group MG is not a read access target, based on the received control signal CMD and address signal A. For this reason, the memory group controller MCNT1 transfers the signal received from the input interface controller 214 to the memory group controller MCNT2 of the subsequent stage.

The memory group controller MCNT2 detects that the memory unit MU in the memory group controller MCNT2's own memory group MG is a read target, based on the received control signal CMD and address signal A. Further, the memory group controller MCNT2 sets the CEB terminal of the read target memory unit MU to a low level and sets the WEB terminal of the read target memory unit MU to a high level. The memory group controller MCNT2 outputs an address A to the A terminal of the read target memory unit MU. As a result, four 128-bit data are sequentially read from the memory cells MC of the read target memory unit MU.

The memory group controller MCNT2 generates a read data enable signal IRDEN (FIG. 14) to transfer the read data signal Q to the memory group controller MCNT of the subsequent stage. The read data enable signal IRDEN is output to the memory group controller MCNT3 as a read data enable signal RDEN.

In addition, the memory group controller MCNT2 sequentially transfers the four 128-bit read data signals Q sequentially read from the memory unit MU to the memory group controller MCNT3 in synchronism with the memory clock signal MCLKxN. Labels Q1 through Q8 illustrated at the Q terminal of the read target MU indicate eight read data signals RD sequentially output by the system bus output controller 226 in FIG. 2. That is, each of the four 128-bit read data signals Q includes data of two read data signals RD.

In a case where the burst length is 8, a pulse of the read data enable signal RDEN is generated two times, and the memory group controller MCNT2 sequentially transfers four 128-bit read data signals Q to the memory group controller MCNT3 for every pulse of the read data enable signal RDEN.

During the read operation, the read data signal Q read from the memory unit MU is subjected to serial-to-parallel conversion by the system bus output controller 226, and is output to the system bus SBUS as the read data signal RD. For this reason, the memory group controller MCNT2 outputs the received control signal CMD and address signal A to the memory group controller MCNT3 together with the read data signal Q.

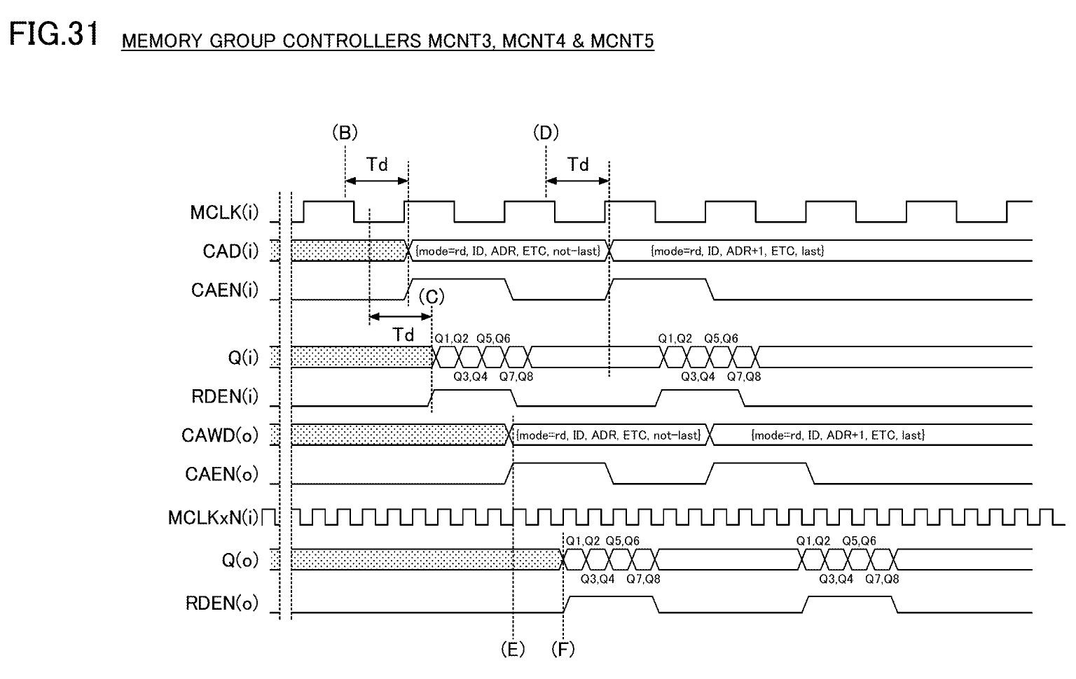

In FIG. 31, labels (B), (C), and (D) indicate timings of the labels (B), (C), and (D) illustrated in FIG. 30. The memory group controller MCNT3 receives the signal output from the memory group controller MCNT2 after the time Td. The memory group controller MCNT3 transfers the received control signal CMD, address signal A, and read data signal Q to the memory group controller MCNT4. The memory group controller MCNT4 transfers the received control signal CMD, address signal A, and read data signal Q to the memory group controller MCNT5. The memory group controller MCNT5 outputs the received control signal CMD and address signal A to the memory controller 200, and sequentially outputs the received read data signal Q to the data converter SPCNV.

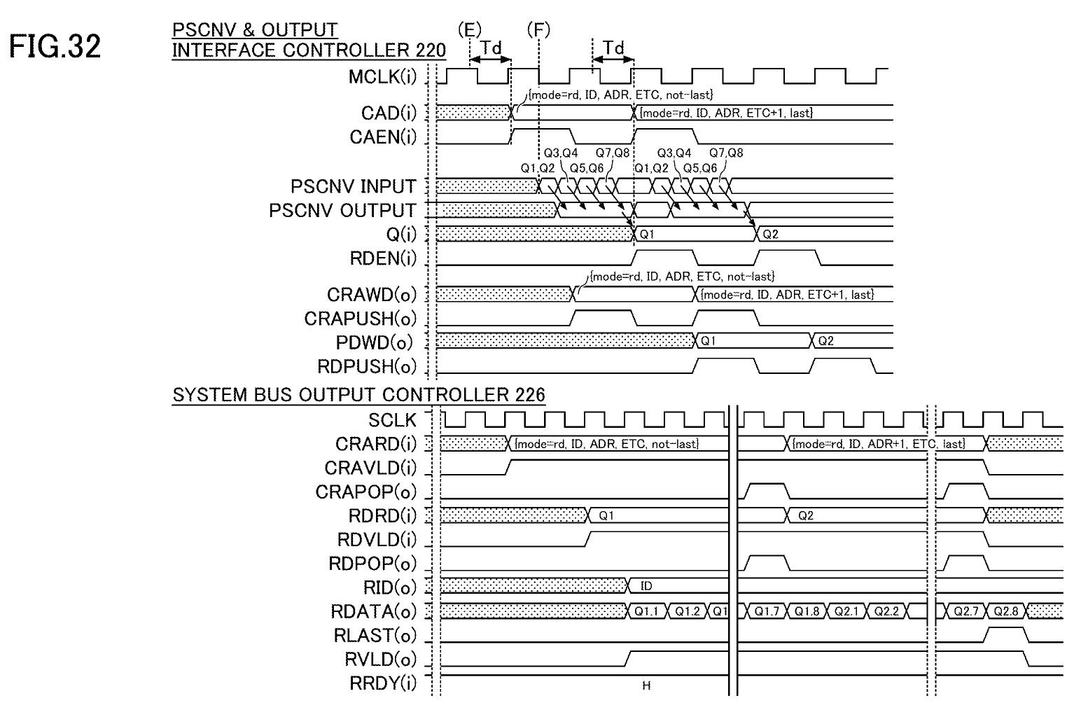

In FIG. 32, labels (E) and (F) indicate timings of the labels (E) and (F) illustrated in FIG. 31. The data converter SPCNV sequentially combines four sequentially received 128-bit read data signals Q to obtain a 512-bit read data signal Q, and outputs the 512-bit read data signal Q to the memory controller 200, for every burst operation. The output interface controller 220 of the memory controller 200 stores (pushes) the received control signal CMD and address signal A in the buffer 222, and stores (pushes) the read data signal Q received from the data converter SPCNV in the buffer 224.

The system bus output controller 226 of the memory controller 200 refers to the CRAVLD signal output from the buffer 222 and the RDVLD signal output from the buffer 224, and waits until the buffers 222 and 224 become readable (active). In a case where the buffers 222 and 224 assume the readable state and the system bus SBUS is in a ready state (RRDY = H), the system bus output controller 226 generates a RID signal and an RDATA signal to be output to the system bus SBUS. The RID signal and the RDATA signal generate a read data signal RDATE (an example of the read data signal RD) and additional information RID and RLAST to be output to the system bus SBUS side, using the control signal CMD and the address signal A held in the buffer 222 and the read data signal Q held in the buffer 224.

The system bus output controller 226 sets a RVLD signal, indicating that an output signal to the system bus SBUS is active, to an active level (RVLD = H). The read data signal from the memory block MBLK is in units of 512 bits, whereas the read data signal on the system bus SBUS side is in units of 64 bits. For this reason, the read data signal is output to the system bus SBUS in eight divisions at a maximum. When a CRAPOP signal and a RDPOP signal are set to the active level (H), the next control signal CMD, address signal A, and read data signal Q are output to the buffers 222 and 224.

In the example illustrated in FIG. 32, the system bus output controller 226 sequentially selects the 512-bit read data signals Q read from the memory block MBLK according to a data bus width of 64 bits on the system bus SBUS side. Data signals Q1.1 through Q1.8 of the first 64 bits are output to the system bus SBUS in 8 clocks. Further, with respect to the next 512 bits of the read data signal Q from the memory block MBLK, data signals Q2.1 through Q2.8 are output to the system bus SBUS in 8 clocks. The system bus output controller 226 sets RLAST to an active level (for example, a high level) when outputting the data signal Q2.8, which is the last read data signal Q, and completes the read operation.

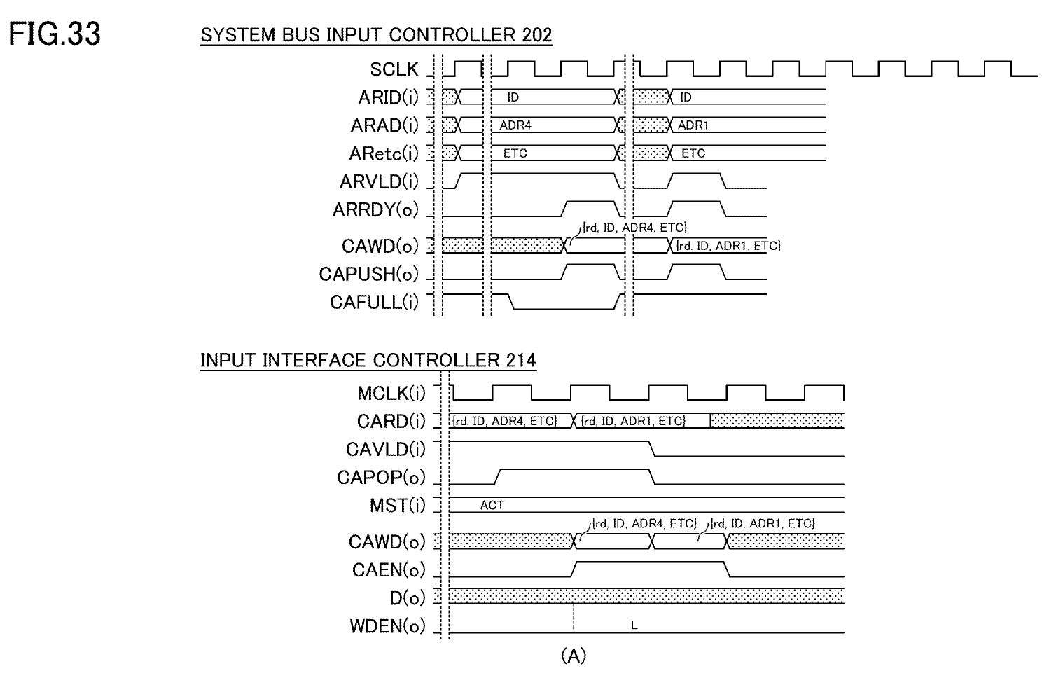

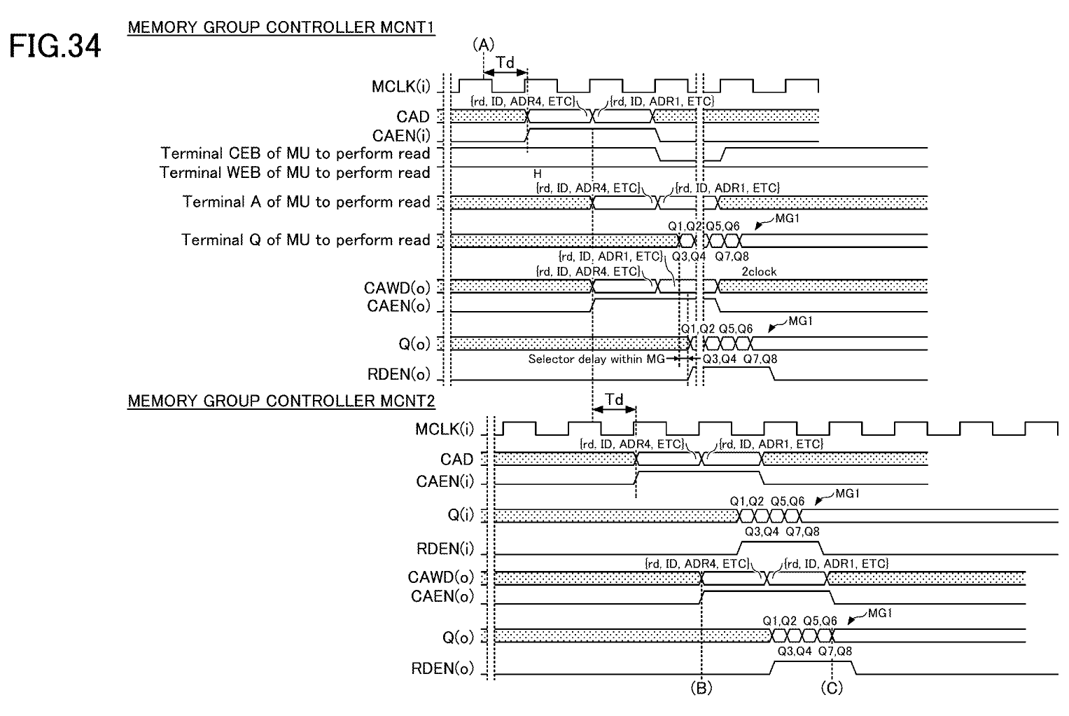

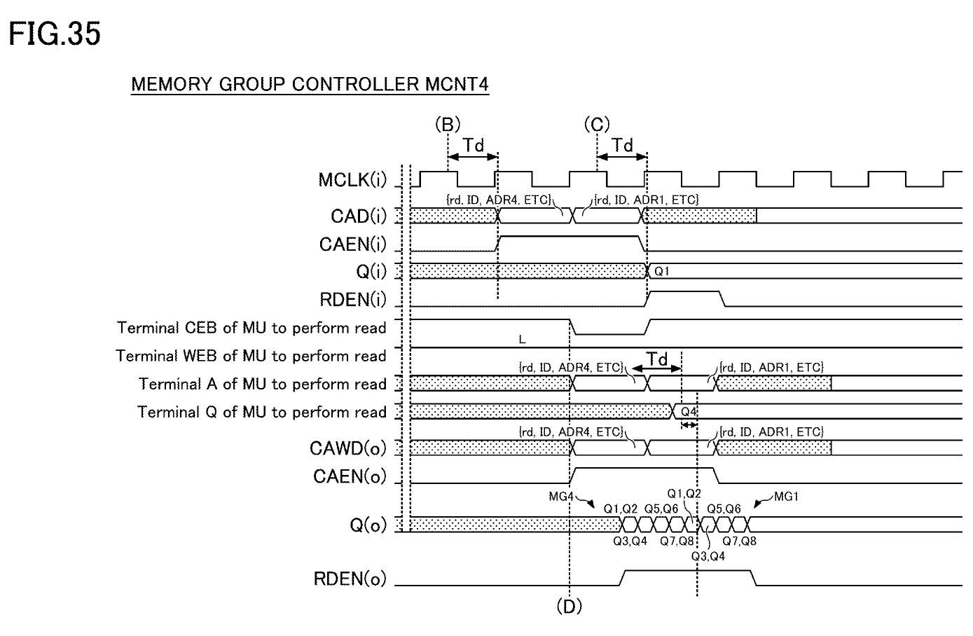

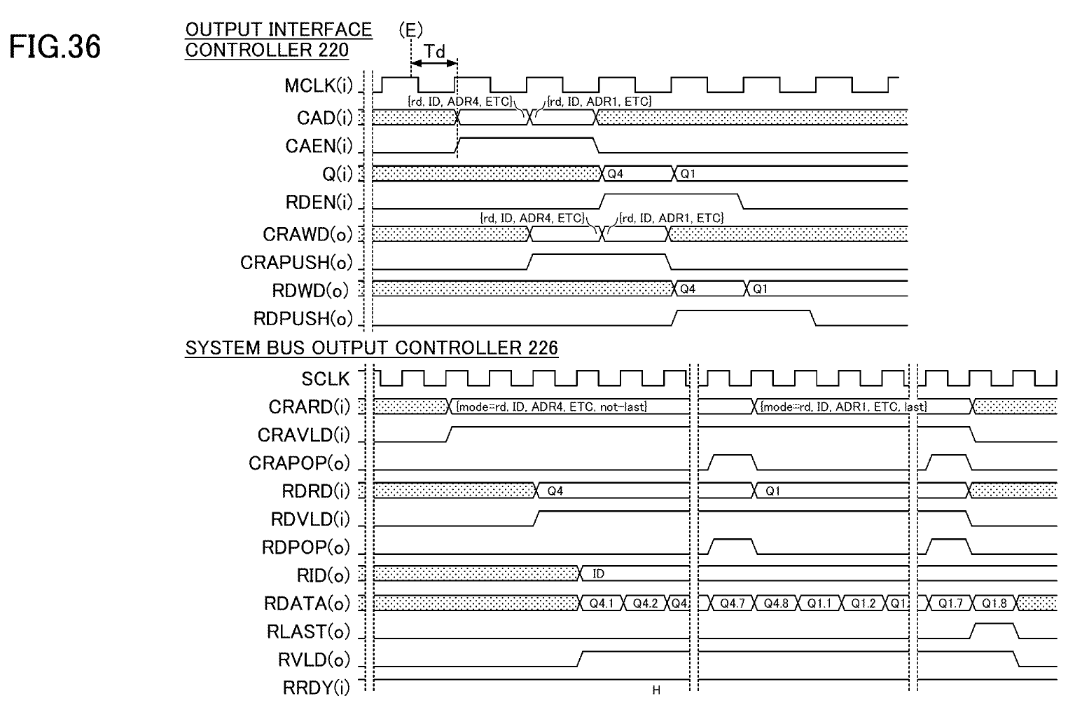

FIGS. 33 through 36 illustrate another example of the timings of signals during the read operation of the memory circuit 100 illustrated in FIG. 1. FIGS. 33 through 36 illustrate an example in which a read request is issued to the memory unit MU of the memory group MG4, and a read request is thereafter issued to the memory unit MU of the memory group MG1.

The operations of the circuit elements illustrated in FIG. 33 through 36 are the same as those of the circuit elements illustrated in FIGS. 29 through 32, except that two read requests are sequentially issued. In other words, in FIGS. 33 through 36, the operation with respect to each read request is the same as the operation illustrated in FIGS. 29 through 32.

In this embodiment, the access request signal, the write data signal D, and the read data signal Q can be transferred between the memory group controllers MCNT in a pipeline-like manner. For this reason, before the read data signal Q in response to one read request is output from the memory block MBLK, for example, other read requests can be sequentially supplied to the memory blocks MBLK. As a result, as illustrated in FIGS. 33 through 36, a read access to the memory group MG4 can be performed during a clock cycle next to the clock cycle in which the read access to the memory group MG1 is performed.

As described above, in the first embodiment, the data converter PSCNV converts the 512-bit write data signal D into four 128-bit write data signals D, and supplies the four 128-bit write data signals D to the memory block MBLK. For this reason, the number of write data lines D wired in the memory block MBLK can be reduced to one-fourth the number of the write data lines D wired in the memory block a case where the data converter PSCNV is not used.

Similarly, the data converter SPCNV converts four 128-bit read data signals Q output from the memory block MBLK into a 512-bit read data signal Q. For this reason, the number of the read data lines Q wired in the memory block MBLK can be reduced to one-fourth the number of the read data lines Q wired in the memory block MBLK in a cased where the data converter SPCNV is not used.

The control line CMD, the address line A, and the write data line D are wired for every memory group MG, and are sequentially electrically connected via the memory group controller MCNT. The control signal CMD, the address signal A, and the write data signal D are not transferred to the memory groups MG on the subsequent stage side of the memory group MG to which the write data signal D is written. Hence, the control line CMD, the address line A, and the write data line D are wired in common to each memory group MG, and the charge and discharge currents of the control line CMD, the address line A, and the write data line D can be suppressed compared to a case where the control signal CMD, the address signal A, and the write data signal D are supplied in common to each memory group MG. As a result, it is possible to reduce the power consumption during the write operation, while suppressing an increase in the access time of the memory circuit 100.

The read data lines to which the read data signal Q is transferred are wired for every memory group MG, and are sequentially electrically connected via the memory group controller MCNT. For this reason, the read data signal Q is not transmitted to the read data line of the memory group MG on the preceding stage side of the memory group MG that performs the read operation. Accordingly, the power consumption of the memory block MBLK during the read operation can be reduced compared to a case where a common read data line is wired to all the memory groups MG.

The 512 memory cells MC of each memory MEM are connected to the word line WL. Data signals are simultaneously read from the memory cells MC on the word line WL selected based on one read command RCMD. The read data is controlled in units of four, and 128 bits can be sequentially output as the read data signal Q in four clock cycles. In addition, the write data signals D sequentially received in four clock cycles can be simultaneously written to all of the memory cells MC based on one write command WCMD recognized from the control signal CMD.

Each memory group controller MCNT sets the memory unit MU that is caused to perform the write operation or the read operation to the active mode ACT, and sets the other memory units MU to the shutdown mode SD or the sleep mode SLP. Hence, it is possible to reduce the power consumption of the memory circuit 100. In addition, each memory group controller MCNT switches the memory unit MU that does not perform the write operation or the read operation for a predetermined period from the active mode ACT to the sleep mode SLP, to further reduce the power consumption of the memory circuit 100.

The memory group controller MCNT is operated in synchronism with the memory clock signal MCLK, and the memory group MG is operated in synchronism with the memory clock signal MCLKxN obtained by multiplying the frequency of the memory clock signals MCLK by four. Thus, even in a case where the 512-bit write data signal D is converted into four 128-bit write data signals D by the data converter PSCNV and written into the memory unit MU, it is possible to achieve the same write rate as when the 512-bit write data signal D is written into the memory unit MU in synchronism with the memory clock signal MCLK.

In addition, in a case where the four 128-bit read data signals Q read from the memory unit MU are converted into the 512-bit read data signal Q by the data converter SPCNV, it is possible to achieve the same read rate as when the 512-bit read data signal Q is read from the memory unit MU in synchronism with the memory clock signal MCLK.

The memory controller 200 and the data converter PSCNV convert eight write data signals WD sequentially received from the system bus SBUS into four write data signals D, and sequentially output the four converted write data signals D to the memory block MBLK to perform the write operation. In addition, the memory controller 200 and the data converter SPCNV convert four read data signals Q sequentially read from the memory block MBLK into eight read data signals RD, and sequentially output the eight read data signals RD to the system bus SBUS. Accordingly, the operating frequency of the memory block MBLK can be made lower than the operating frequency of the system bus SBUS, and the power consumption of the memory block MBLK can be reduced. Because the operating frequency of the memory block MBLK can be lowered, it is possible to allow for a sufficient operating margin of the memory group controller MCNT and the memory group MG, and the timing design of the circuit or the like can easily be performed.

The memory circuit 100 includes the memory group controllers MCNT and memory groups MG alternately arranged between the input-side memory controller 200 and the output-side memory controller 200. During the read operation, the memory block MBLK receives the access request signal from the input-side memory controller 200, and outputs the read data signal Q to the output-side memory controller 200. Accordingly, a sum of the length of the signal line for transferring the access request signal from the memory controller 200 to the read target memory group MG and the length of the signal line for transferring the read data signal Q to the memory controller 200 can be made approximately constant regardless of the access position. As a result, it is possible to suppress the read access time from varying depending on the position of the memory group MG which performs the read operation.

The control line CMD through which the access request signal is transferred and the address line A through which the address signal A is transferred are wired for every memory group MG, and are sequentially electrically connected via the memory group controller MCNT. Accordingly, the access can be controlled for every memory group MG by each memory group controller MCNT. Because the control line CMD and the address line A are not wired across a plurality of memory groups MG, an increase in the wiring load can be suppressed. As a result, the power consumption can be reduced, while suppressing an increase in the access time of the memory circuit 100.

The number of clock cycles (for example, the number of clocks of the clock signal MCLKxN) required to transfer the access request signal, the write data signal D, and the read data signal Q between the pair of memory group controllers MCNT arranged on both sides of the memory group MG is set the same for these signals. Accordingly, even in a case where the number of memory groups MG is increased or decreased to newly design another memory circuit having a different storage capacity, the timing design can easily be performed.

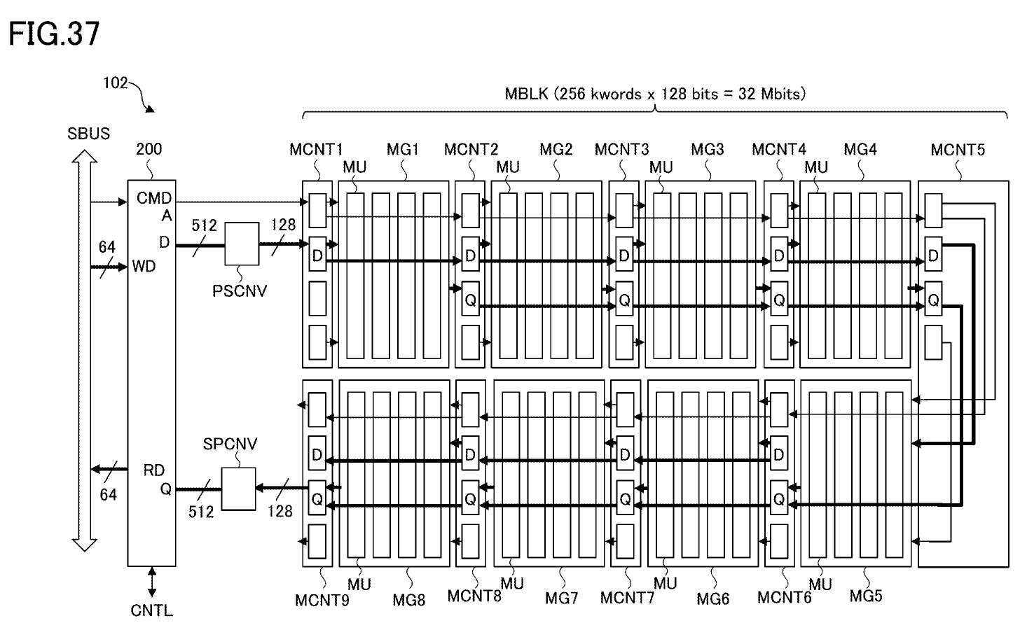

FIG. 37 illustrates an example of a configuration of a memory circuit according to a second embodiment. A detailed description of elements that are the same the elements illustrated in FIG. 1 will be omitted. In the memory circuit 102 illustrated in FIG. 37, the memory block MBLK includes nine memory group controllers MCNT1 through MCNT9, and eight memory groups MG1 through MG8 disposed between adjacent memory group controllers MCNT, respectively. The configuration of each memory group controller MCNT is the same as the configuration of the memory group controller MCNT illustrated in FIG. 14. The configuration of each memory group MG is the same as the configuration of the memory group MG illustrated in FIG. 4. For this reason, the memory circuit 102 has a storage capacity of 32 Mbits (256 kwords × 128 bits) that us two times the storage capacity of the memory circuit 100 illustrated in FIG. 3.

In this embodiment, the control line CMD, the address line ADR, the write data line D, and the read data line Q are folded back at the memory group controller MCNT5 in the middle of the nine memory group controllers MCNT1 through MCNT9. Hence, the input-side memory controller 200 and the output-side memory controller 200 illustrated in FIG. 3 to be collectively arranged into one memory controller. The configuration of the memory controller 200 is the same as the configuration of the memory controller 200 illustrated in FIG. 2.

The 128-bit write data signal D output from the memory controller 200 is output to the memory group controller MCNT1 as four 512-bit write data signals D via the data converter PSCNV. The four 128-bit read data signals Q output from the memory group controller MCNT9 are output to the memory controller 200 as the 512-bit read data signal Q via the data converter SPCNV.

As described above, the second embodiment can also obtain the same effects as those obtainable in the first embodiment. For example, the number of write data lines D wired in the memory block MBLK can be reduced to one-fourth compared to the case where the data converter PSCNV is not used. Similarly, the number of the read data lines Q wired in the memory block MBLK can be reduced to one-fourth compared to the case where the data converter SPCNV is not used. As a result, the power consumption during the read operation can be reduced compared to the case where the 512-bit data signal is input to and output from the memory block MBLK.

The control line CMD, the address line A, and the write data line D are wired in common to the plurality of memory groups MG, and the charge and discharge currents of the control line CMD, the address line A, and the write data line D can be suppressed compared to the case where the control line CMD, the address signal A, and the write data signal D are supplied in common to each memory group MG. As a result, it is possible to reduce the power consumption during the write operation, while suppressing an increase in the access time of the memory circuit 102.

The memory group controller MCNT is operated in synchronism with the memory clock signal MCLK, and the memory group MG is operated in synchronism with the memory clock signal MCLKxN obtained by multiplying the frequency of the memory clock signal MCLK by four. Thus, even in a case where the 512-bit write data signal D is converted into four 128-bit write data signals D by the data converter PSCNV and written into the memory unit MU, it is possible to achieve the same write rate as when the 512-bit write data signal D is written into the memory unit MU in synchronism with the memory clock signal MCLK.

In addition, even in a case where the four 128-bit read data signals Q read from the memory unit MU are converted into the 512-bit read data signal Q by the data converter SPCNV, it is possible to achieve the same read rate as when the 512-bit read data signal Q is read from the memory unit MU in synchronism with the memory clock signal MCLK. As a result, the dynamic power of the memory circuit can be reduced by reducing the charge and discharge currents of the data line without lowering the access efficiency.

Furthermore, in the second embodiment, the memory group controller MCNT and the memory unit MU are arranged in a folded manner, so that the input-side memory controller 200 and the output-side memory controller 200 can be integrated into a single layout. As a result, even in a case where the storage capacity is two times that of the memory circuit 100 illustrated in FIG. 1, for example, the memory circuit 102 can be arranged in a compact layout.

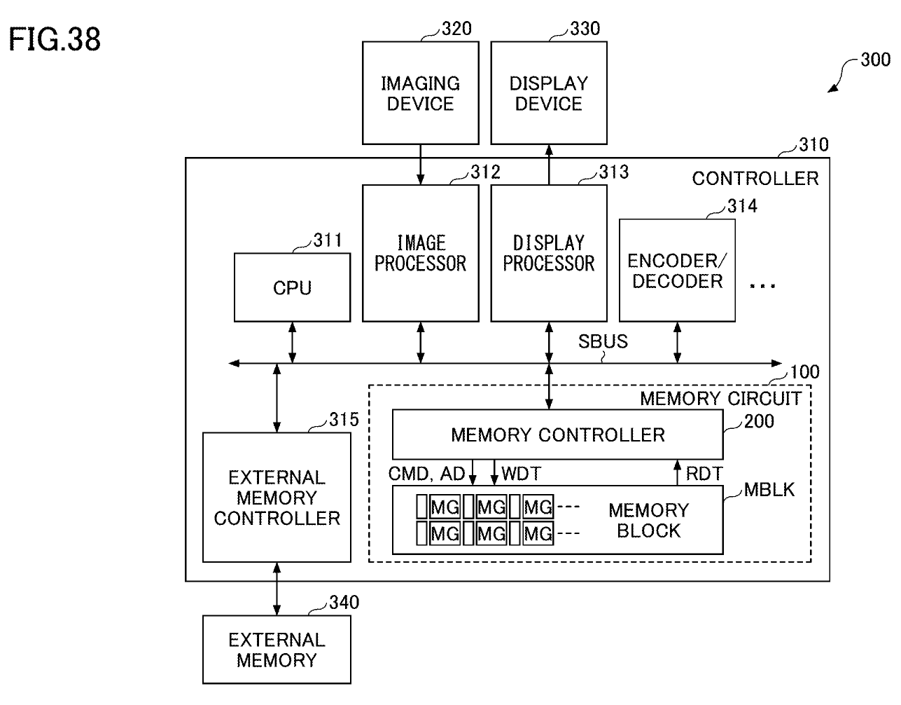

FIG. 38 illustrates an example of a configuration of a system 300 in which the memory circuit 100 illustrated in FIG. 1 is mounted. The system 300 may include the memory circuit 102 illustrated in FIG. 37 in place of the memory circuit 100. For example, the system 300 is a head-mounted device, such as AR/VR glasses capable of processing video images, a digital camera, a gaming device, or the like. The system 300 may be an image processing system mounted on a vehicle. The system in which the memory circuit 100 is mounted is not limited to the configuration of the system 300.

The system 300 includes a controller 310, an imaging device 320, a display device 330, and an external memory 340. The controller 310 includes a central processing unit (CPU) 311, an image processor 312, a display processor 313, an encoder/decoder 314, an external memory controller 315, and the memory circuit 100 illustrated in FIG. 1, which are connected to one another via a system bus SBUS. For example, the controller 310 may be designed as a system LSI.

The CPU 311 controls the entire system 300. The image processor 312 processes image data acquired by the imaging device 320, converts the processed image data into frame image data that can be displayed on the display device 330, and stores the frame image data in the memory circuit 100. The display processor 313 reads the frame image data from the memory circuit 100 and displays an image on the display device 330. The encoder/decoder 314 encodes the image data before being stored in the memory circuit 100 and decodes the compressed image data read from the memory circuit 100. The external memory controller 315 controls access to an external memory 340, such as a dynamic random access memory (DRAM) or the like.

For example, a resolution of the video images processed by the system 300 are video graphics array (VGA), full high vision, 4K, or the like. The memory circuit 100 of the system 300 includes a number of memory groups MG (not illustrated) selected in accordance with the resolution of the video images. As described above, even when the number of memory groups MG that are mounted increases or decreases, the clock cycle required for transferring signals among the memory group controllers MCNT does not change, and thus, the timing design can easily be performed, and an increase in the access time can be suppressed.

According to the disclosed technique, it is possible to reduce the dynamic power during the memory access operation.

The description above use terms such as "determine", "identify", or the like to describe the embodiments, however, such terms are abstractions of the actual operations that are performed. Hence, the actual operations that correspond to such terms may vary depending on the implementation, as is obvious to those skilled in the art.

Although the embodiments are numbered with, for example, “first,” or “second,” the ordinal numbers do not imply priorities of the embodiments. Many other variations and modifications will be apparent to those skilled in the art.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A memory circuit comprising:
a plurality of memory groups configured to execute a write operation or a read operation in response to a request signal, each memory group of the plurality of memory groups including a plurality of memories, each memory of the plurality of memories including a plurality of memory cells;
a plurality of memory group controllers provided in correspondence with the plurality of memory groups, respectively;
a first memory controller configured to output a request signal received from outside to an adjacent memory group controller of the plurality of memory group controllers; and
a first data converter configured to divide a first write data signal received from the first memory controller into n second write data signals, and sequentially output the n second write data signals to the adjacent memory group controller, where n is an integer greater than or equal to two,
wherein the plurality of memory group controllers sequentially write the n second write data signals into one memory of the plurality of memories of a corresponding memory group in a case where a write address signal included in the request signal received from the first memory controller or a memory group controller of a preceding stage indicates the corresponding memory group, and transfers the request signal and the n second write data signals to the memory group controller in the preceding stage in a case where the write address signal does not indicate the corresponding memory group.

2. The memory circuit as claimed in claim 1, wherein:
each memory group of the plurality of memory groups includes a write data line that sequentially transfers the write data signal via a memory group controller of a subsequent stage, and
a transfer of the write data signal to a write data line of a memory group of a stage subsequent to the memory group to which the write data signal is written is masked.

3. The memory circuit as claimed in claim 1, further comprising:
a second data converter configured to integrate n first read data signals sequentially read from the one memory of the plurality of memory groups via at least one memory group controller of the plurality of memory group controllers into a second read data signal; and
a second memory controller configured to output the second read data signal integrated by the second data converter,
wherein the plurality of memory group controllers sequentially read data held in the one memory of the corresponding memory group in a case where a read address signal included in the request signal received from the first memory controller or the memory group controller of the preceding stage indicates the corresponding memory group, and transfers the request signal to the memory group controller of a subsequent stage in a case where the read address signal does not indicate the corresponding memory group.

4. The memory circuit as claimed in claim 3, wherein:
each memory group of the plurality of memory groups includes a read data line that sequentially transfers the read data signal via the memory group controller of the subsequent stage, and
the read data signal is not transmitted to a read data line of a memory group of a stage preceding the memory group from which the read data signal is read.

5. The memory circuit as claimed in claim 3, wherein in each memory group of the plurality of memory groups:
a number of data terminals that receive the second write data signal is 1/n of a number of data terminals of the first memory controller that output the first write data signal, and
the number of data terminals that output the first read data signal is 1/n of a number of data terminals of the second memory controller that receive the second read data signal.

6. The memory circuit as claimed in claim 3, wherein each memory of the plurality of memories includes:
m memory cells coupled to a plurality of word lines extending in a first direction, respectively, where m is an integer greater than or equal to two;
m bit line pairs coupled to columns of the m memory cells arranged in a second direction intersecting the first direction, respectively;
m precharge circuits and m sense amplifiers coupled to the m bit line pairs, respectively;
m read latches and m read switches sequentially coupled to the m sense amplifiers, respectively, wherein the m precharge circuits, the m sense amplifiers, the m read latches, and the m read switches are coupled to each bit line pair of the m bit line pairs, respectively; and
m/n buffers coupled to each group of n read switches, respectively.

7. The memory circuit as claimed in claim 6, wherein:
each memory of the plurality of memories includes a memory array control circuit, and
the memory array control circuit generates one column readout signal of n column readout signals for selecting m/n read switches, in response to the readout address signal included in the request signal.

8. The memory circuit as claimed in claim 7. wherein the one memory includes:
selecting one word line of the plurality of word lines in response to the request signal and the read address signal of one time, reading data from the m memory cells coupled to the selected word line, and storing the data in the m read latches; and
sequentially reading out m/n pieces of data from data stored in the m read latches via the m/n read switches in response to the n column readout signals, and outputting the first read data signal including the m/n pieces of data n times.

9. The memory circuit as claimed in claim 3, wherein each memory of the plurality of memories includes:
m memory cells coupled to a plurality of word lines extending in a first direction, respectively, where m is an integer greater than or equal to two;
m bit line pairs coupled to columns of m memory cells arranged in a second direction intersecting the first direction;
m precharge circuits and m write buffers coupled to the m bit line pairs, respectively;
m write latches and m write selectors sequentially coupled to the m write buffers, respectively, wherein the m precharge circuits, the m write buffers, the m write latches, and the m write selectors are coupled to each bit line pair of the m bit line pairs; and
m/n flip-flop circuits coupled to each write selector of the n write selectors, respectively.

10. The memory circuit as claimed in claim 9, wherein:
each memory of the plurality of memories includes a memory array control circuit, and
the memory array control circuit generates one column write signal of n column write signals for selecting the m/n write selectors in response to the write address signal included in the request signal.

11. The memory circuit as claimed in claim 10, wherein the one memory includes:
sequentially selecting the m/n write selectors by the n column write signals in response to the request signal and the write address signal of one time, and sequentially storing the second write data signal including m/n pieces of data in the m/n write latches; and
selecting one word line of the plurality of word lines in response to the write address signal, and writing n second write data signals including m data stored in the m write latches into the m memory cells coupled to the selected word line.

12. The memory circuit as claimed in claim 3, wherein:
the plurality of memory groups includes a plurality of memory units, each memory unit of the plurality of memory units including the plurality of memories,
each memory of the plurality of memories includes a plurality of memory cells coupled to a plurality of word lines, respectively, and
the one memory includes:
selecting one word line of the plurality of word lines in response to the write address signal included in the request signal, and sequentially writing the n second write data signals to the plurality of memory cells coupled to the selected word line; and
selecting one word line of the plurality of word lines in response to the read address signal included in the request signal, and sequentially reading the n pieces of data from the plurality of memory cells coupled to the selected word line.

13. The memory circuit as claimed in claim 12, wherein each memory of the plurality of memories includes:
a plurality of bit line pairs, each bit line pair of the plurality of bit line pairs being coupled to a column of the memory cells arranged in a second direction intersecting a first direction in which the plurality of word lines extend;
a plurality of data latches coupled to the plurality of bit line pairs, respectively;
a data line through which the second write data signal or the first read data signal is transmitted; and
a data selector configured to couple the data line to one data latch of the plurality of data latches in response to the second write address signal or the first read address signal.

14. The memory circuit as claimed in claim 12, wherein:
each memory unit of the plurality of memory units has a low power mode in which the write operation and the read operation are not performed while holding data, and an active mode in which the write operation or the read operation is performed,
the memory group controller corresponding to each memory group of the plurality of memory groups sets the memory unit that is caused to perform the write operation or the read operation to the active mode, and
setting the memory unit in which the write operation or the read operation is not performed for a predetermined period to the low power mode.

15. The memory circuit as claimed in claim 3, wherein:
the first memory controller operates in synchronism with a received first clock signal, and outputs the first clock signal and a second clock signal obtained by multiplying a frequency of the first clock signal by n to the adjacent memory group controller,
each memory group controller of the plurality of memory group controllers operates in synchronism with the first clock signal,
each memory group of the plurality of memory groups operates in synchronism with the second clock signal, and
the second memory controller operates in synchronism with the first clock signal.

16. The memory circuit as claimed in claim 15, wherein:
the first data converter converts the first write data signal received from the first memory controller in synchronism with the first clock signal into the n second write data signals in synchronism with the second clock signal, and sequentially outputs the n second write data signals to the adjacent memory group controller,
each memory group controller of the plurality of memory group controllers outputs the first clock signal received from the first memory controller or a memory group controller of the preceding stage to the memory group controller of the subsequent stage or the second memory controller, and outputs the second clock signal received from the first memory controller or the memory group controller of the preceding stage to the corresponding memory group and the memory group controller of the subsequent stage, and
the second data converter converts the n first read data signals sequentially received in synchronism with the second clock signal into the second read data signal in synchronism with the first clock signal, and outputs the second read data signal to the second memory controller.

17. The memory circuit as claimed in claim 3, wherein:
the first memory controller converts b 1-bit third write data signals sequentially received from the outside into a (a × b)-bit first write data signal, and outputs the (a × b)-bit first write data signal to the first data converter, where a is an integer greater than or equal to one, and b is an integer greater than or equal to two, and
the second memory controller converts a (a × b)-bit second read data signal received from the second data converter into b a-bit third read data signals, and sequentially outputs the b a-bit third read data signals to the outside.

18. The memory circuit as claimed in claim 1, wherein:
the plurality of memories are static random access memories, and
the second transistor is a metal oxide semiconductor transistor.

19. The memory circuit as claimed in claim 2, wherein:
the plurality of memories are static random access memories, and
the second transistor is a metal oxide semiconductor transistor.
